(19) United States
(12) Patent Application Publication
(10) Pub. No.: US 2022/0229535 A1
(43) Pub. Date: Jul. 21, 2022

(54) Systems and Methods for Manipulating Views and Shared Objects in XR Space

(71) Applicant: Samsung Electronics Company, Ltd., SUWON SI (KR)

(72) Inventors: Edgar Charles Evangelista, San Jose, CA (US); Aaron Samuel Faucher, San Mateo, CA (US); Jaehyun Kim, San Francisco, CA (US); Andrew R. McHugh, San Jose, CA (US)

(21) Appl. No.: 17/362,232

(22) Filed: Jun. 29, 2021

Related U.S. Application Data
(60) Provisional application No. 63/139,218, filed on Jan. 19, 2021.

(51) Int. Cl. G06F 3/0481; G06F 3/0484; G06F 3/0488; H04N 7/14; G06T 19/20; G06T 19/00

(52) U.S. Cl. CPC G06F 3/04815; G06F 3/04845; G06F 3/0488; G06F 2203/04806; G06T 19/20; G06T 19/006; H04N 7/141

(57) ABSTRACT

In one embodiment, a method includes rendering a first sequence of image frames of an extended reality (XR) video call on touchscreen displays of an electronic device, wherein the first sequence of images portrays a shared XR space, and wherein the XR video call is between a first user of the electronic device and one or more second users, receiving gesture inputs associated with manipulating parameters of the XR space during the XR video call via the touchscreen displays, determining transformations within the XR space responsive to the gesture inputs, wherein the determination is based on a gesture type associated with each of the gesture inputs, and rendering a second sequence of image frames of the XR video call on the touchscreen displays, wherein the second sequence of images portrays the transformations to the XR space.

### PRIORITY

This application claims the benefit under 35 U.S.C. § 119(e) of U.S. Provisional Patent Application No. 63/139,218, filed 19 Jan. 2021, which is incorporated herein by reference.

### TECHNICAL FIELD

This disclosure relates generally to database and file management within network environments, and in particular relates to data manipulation in XR space.

### BACKGROUND

An extended reality (XR) system may generally include a computer-generated environment and/or a real-world environment that includes at least some XR objects. Such an XR system or world and associated XR objects typically include various applications (e.g., video games), which may allow users to utilize these XR artifacts by manipulating their presence in the form of a computer-generated representation (e.g., avatar). In typical XR systems, image data may be rendered on, for example, a lightweight, head-mounted display (HMD) that may be coupled through a physical wired connection to a base graphics generation device responsible for generating the image data. In some instances, it may be desirable to couple the HMD to the base graphics generation device via a wireless network connection.

With these tools, users generate new forms of reality by bringing digital objects into the physical world and bringing physical world objects into the digital world. XR technologies have applications in almost every industry, such as architecture, automotive industry, sports training, real estate, mental health, medicine, health care, retail, space travel, design, engineering, interior design, television and film, media, advertising, marketing, libraries, education, news, music, and travel.

A video call is a call using an Internet connection, sometimes called VoIP, that utilizes video to transmit a live picture of the person making the call. Video calls are made using a computer's webcam or other electronic devices with a video-capable camera, like a smartphone, tablet, or video-capable phone system. A video call can also be, for example, a “holocall” or depth video call, where the user's two-dimensional video is projected into a three-dimensional space.

### BRIEF DESCRIPTION OF THE DRAWINGS

FIG. 1 illustrates an example electronic device.

FIG. 2 illustrates an example extended reality (XR) system.

FIG. 3 illustrates an example network.

FIG. 4 illustrates an example block diagram of an example configuration of an electronic device.

FIG. 5 illustrates an example block diagram of a program module.

FIG. 6 illustrates example flow diagrams for sharing media content from an electronic device in an XR video call.

FIG. 7 illustrates an example user interface for sharing media content to the media wall.

FIG. 8 illustrates an example flow diagram for sharing media content from the Internet.

FIG. 9A illustrates an example flow diagram for sharing the media on the media wall with a long press using a single finger with respect to the phone user device.

FIG. 9B illustrates the example flow diagram for sharing the media on the media wall with a tap using a single finger with respect to other user's phone or AR glasses device.

FIG. 10 illustrates an example shared XR space viewed on a phone user's screen.

FIG. 11A illustrates an example diagram flow for sharing media content using a tap and drag with a single finger with respect to the phone user device.

FIG. 11B illustrates the example flow diagram for sharing media content using a tap and drag with a single finger with respect to other user's phone or AR glasses device.

FIG. 12 illustrates example gesture inputs and corresponding media sharing processes.

FIG. 13A illustrate an example XR object in the XR space in an XR video call.

FIG. 13B illustrate an example manipulation of the XR object by dragging it with a single finger.

FIG. 14A illustrate another example XR object in the XR space in an XR video call.

FIG. 14B illustrate an example rotated XR object.

FIG. 15A illustrate another example XR object in the XR space in an XR video call.

FIG. 15B illustrate an example manipulation of the XR object by dragging it with two fingers.

FIG. 16A illustrate an example view in an XR video call.

FIG. 16B illustrate an example manipulation of the view by double tapping it with a single finger.

FIG. 17A illustrate another example view in an XR video call.

FIG. 17B illustrate an example manipulation of the view by dragging it with a single finger.

FIG. 18A illustrate another example view in an XR video call.

FIG. 18B illustrate an example manipulation of the view by pinching it with two fingers.

FIG. 19 illustrates an example diagram flow for manipulating the parameters of the XR space with respect to different interactions.

FIG. 20 illustrates an example locking of a shared object in an XR video call.

FIG. 21A illustrates an example diagram flow for adjusting the view in an XR video call with respect to the phone user device.

FIG. 21B illustrates the example flow diagram for adjusting the view in the XR video call with respect to other user's phone or AR glasses device.

FIG. 22A illustrates an example diagram flow for adjusting the shared media content in an XR video call with respect to the phone user device.

FIG. 22B illustrates the example flow diagram for adjusting the view in the XR video call with respect to other user's phone or AR glasses device.

FIG. 23 illustrates an example isolation view in an XR video call.

FIG. 24 illustrates an example diagram flow for using an isolation view to view an XR object on a phone user device.

FIG. 25A illustrates an example starting of an XR video call.

FIG. 25B illustrates an example view of the XR space during the XR video call by the phone user.

FIG. 25C illustrates an example sharing of a media content from the Internet by the phone user.

FIG. 25D illustrates an example view of the shared media content by the other user wearing AR glasses.

FIG. 25E illustrates an example sharing of a media content from the gallery of the phone by the phone user.

FIG. 25F illustrates an example view of the shared media content by the other user wearing AR glasses.

FIG. 25G illustrates an example 3D scanning of an object by the phone user.

FIG. 25H illustrates an example sharing of the scanned 3D object by the phone user.

FIG. 25I illustrates an example sharing of a media content from the Internet by the phone user.

FIG. 25J illustrates an example view of the shared media content by the other user wearing AR glasses.

FIG. 25K illustrates an example highlight of the shared media content by the phone user.

FIG. 25L illustrates an example view of the highlighted media content by the other user wearing AR glasses.

FIG. 25M illustrates an example sharing of a 3D object by the other user wearing AR glasses.

FIG. 25N illustrates an example view of the shared 3D object by the phone user.

FIG. 26 illustrates is a flow diagram of a method for manipulating parameters of an XR space during an XR video call.

FIG. 27 illustrates an example computer system that may be utilized to perform manipulating parameters of an XR space during an XR video call.

### DESCRIPTION OF EXAMPLE EMBODIMENTS

### Mobile Client System Overview

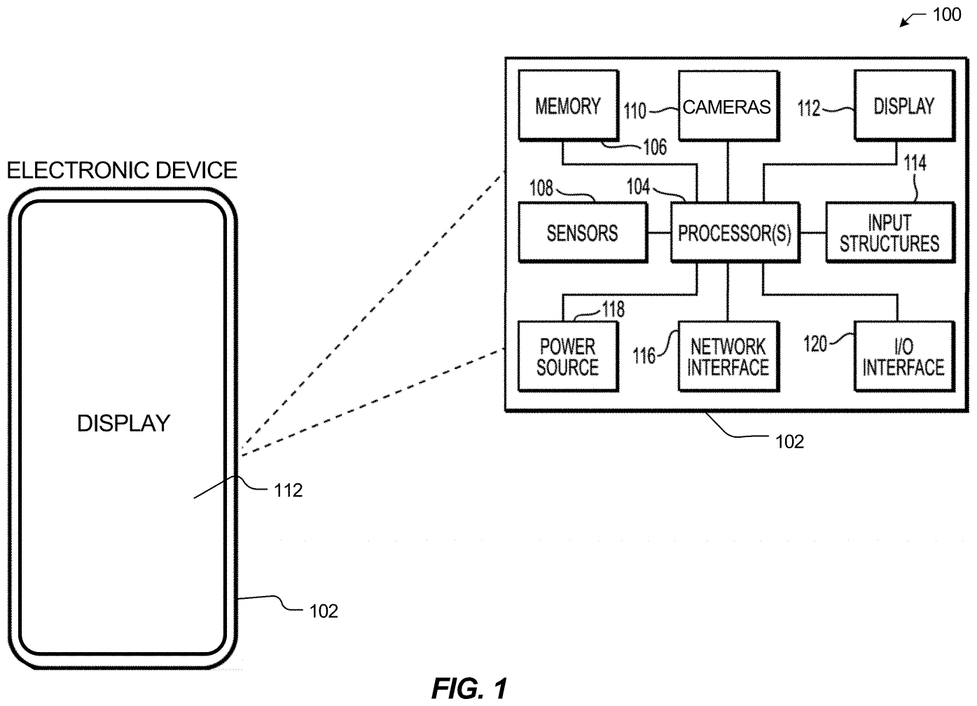

FIG. 1 illustrates an example electronic device 100. In particular embodiments, the electronic device 100 may comprise at least one of a smartphone, a tablet personal computer (PC), a mobile phone, a video phone, an e-book reader, a desktop PC, a laptop computer, a netbook computer, a workstation, a PDA (personal digital assistant), a portable multimedia player (PMP), an MP3 player, a mobile medical device, a camera, or a wearable device (e.g., smart glasses, a head-mounted device (HMD), electronic clothes, an electronic bracelet, an electronic necklace, an electronic accessory, an electronic tattoo, a smart mirror, or a smart watch).

In particular embodiments, the electronic device 100 may be a smart home appliance. Examples of the smart home appliance may comprise at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box , a gaming console, an electronic dictionary, an electronic key, a camcorder, or an electronic picture frame.

In particular embodiments, the electronic device 100 may comprise at least one of various medical devices (e.g., diverse portable medical measuring devices (a blood sugar measuring device, a heartbeat measuring device, or a body temperature measuring device), a magnetic resource angiography (MRA) device, a magnetic resource imaging (MM) device, a computed tomography (CT) device, an imaging device, or an ultrasonic device), a navigation device, a global positioning system (GPS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, automatic teller's machines (ATMs), point of sales (POS) devices, or Internet of Things devices (e.g., a bulb, various sensors, an electric or gas meter, a sprinkler, a fire alarm, a thermostat, a street light, a toaster, fitness equipment, a hot water tank, a heater, or a boiler).

In particular embodiments, the electronic device 100 may comprise at least one of part of a piece of furniture or building/structure, an electronic board, an electronic signature receiving device, a projector, or various measurement devices (e.g., devices for measuring water, electricity, gas, or electromagnetic waves).

In particular embodiments, the electronic device 100 may be one or a combination of the above-listed devices. The electronic device may be a flexible electronic device. The electronic device disclosed herein may be not limited to the above-listed devices and may comprise new electronic devices depending on the development of technology.

Hereinafter, electronic devices 100 are described with reference to the accompanying drawings, according to various embodiments of the present disclosure. As used herein, the term “user” may denote a human or another device (e.g., an artificial intelligent electronic device) using the electronic device 100.

In particular embodiments, the electronic device 100 may include, for example, any of various personal electronic devices 102, such as a mobile phone electronic device, a tablet computer electronic device, a laptop computer electronic device, and so forth. In particular embodiments, as further depicted by FIG. 1, the personal electronic device 102 may include, among other things, one or more processor(s) 104, memory 106, sensors 108, cameras 110, a display 112, input structures 114, network interfaces 116, a power source 118, and an input/output (I/O) interface 120. It should be noted that FIG. 1 is merely one example of a particular implementation and is intended to illustrate the types of components that may be included as part of the electronic device 100.

In particular embodiments, the one or more processor(s) 104 may be operably coupled with the memory 106 to perform various algorithms, processes, or functions. Such programs or instructions executed by the processor(s) 104 may be stored in any suitable article of manufacture that includes one or more tangible, computer-readable media at least collectively storing the instructions or routines, such as the memory 106. The memory 106 may include any suitable articles of manufacture for storing data and executable instructions, such as random-access memory (RAM), read-only memory (ROM), rewritable flash memory, hard drives, and so forth. Also, programs (e.g., an operating system) encoded on such a computer program product may also include instructions that may be executed by the processor(s) 104 to enable the electronic device 100 to provide various functionalities.

In particular embodiments, the sensors 108 may include, for example, one or more cameras (e.g., depth cameras), touch sensors, microphones, motion detection sensors, thermal detection sensors, light detection sensors, time of flight (ToF) sensors, ultrasonic sensors, infrared sensors, or other similar sensors that may be utilized to detect various user inputs (e.g., user voice inputs, user gesture inputs, user touch inputs, user instrument inputs, user motion inputs, and so forth). The cameras 110 may include any number of cameras (e.g., wide cameras, narrow cameras, telephoto cameras, ultra-wide cameras, depth cameras, and so forth) that may be utilized to capture various 2D and 3D images. The display 112 may include any display architecture (e.g., AMLCD, AMOLED, micro-LED, and so forth), which may provide further means by which users may interact and engage with the electronic device 100. In particular embodiments, as further illustrated by FIG. 1, one more of the cameras 110 may be disposed behind, underneath, or alongside the display 112 (e.g., one or more of the cameras 110 may be partially or completely concealed by the display 112), and thus the display 112 may include a transparent pixel region and/or semi-transparent pixel region through which the one or more concealed cameras 110 may detect light, and, by extension, capture images. It should be appreciated that the one more of the cameras 110 may be disposed anywhere behind or underneath the display 110, such as at a center area behind the display 110, at an upper area behind the display 110, or at a lower area behind the display 110.

In particular embodiments, the input structures 114 may include any physical structures utilized to control one or more global functions of the electronic device 100 (e.g., pressing a button to power “ON” or power “OFF” the electronic device 100). The network interface 116 may include, for example, any number of network interfaces suitable for allowing the electronic device 100 to access and receive data over one or more cloud-based networks (e.g., a cloud-based service that may service hundreds or thousands of the electronic device 100 and the associated users corresponding thereto) and/or distributed networks. The power source 118 may include any suitable source of power, such as a rechargeable lithium polymer (Li-poly) battery and/or an alternating current (AC) power converter that may be utilized to power and/or charge the electronic device 100 for operation. Similarly, the I/O interface 120 may be provided to allow the electronic device 100 to interface with various other electronic or computing devices, such as one or more auxiliary electronic devices.

### Extended Reality (XR) System Overview

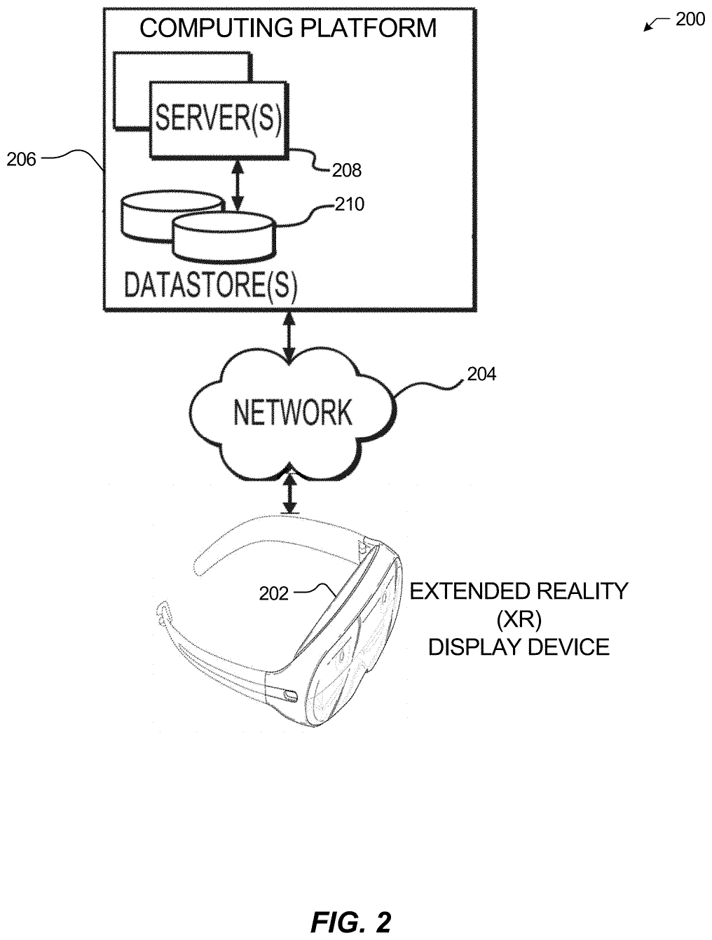

FIG. 2 illustrates an example extended reality (XR) system 200. XR stands for extended reality, which is a term referring to all real-and-virtual combined environments and human-machine interactions generated by computer technology and wearables, where the ‘X’ represents a variable for any current or future spatial computing technologies. XR may include representative forms such as augmented reality (AR), mixed reality (MR) and virtual reality (VR) and the areas interpolated among them. In particular embodiments, the XR system 200 may include an XR display device 202, a network 204, and a computing platform 206. In particular embodiments, a user may wear the XR display device 202 that may display visual extended reality content to the user. The XR display device 202 may include an audio device that may provide audio extended reality content to the user. In particular embodiments, the XR display device 202 may include one or more cameras which can capture images and videos of environments. The XR display device 202 may include an eye tracking system to determine the vergence distance of the user. In particular embodiments, the XR display device 202 may include a lightweight head-mounted display (HIVID) (e.g., goggles, eyeglasses, spectacles, a visor, and so forth). In particular embodiments, the XR display device 202 may also include a non-HMD device, such as a lightweight handheld display device or one or more laser projecting spectacles (e.g., spectacles that may project a low-powered laser onto a user's retina to project and display image or depth content to the user). In particular embodiments, the network 204 may include, for example, any of various wireless communications networks (e.g., WLAN, WAN, PAN, cellular, WMN, WiMAX, GAN, 6LowPAN, and so forth) that may be suitable for communicatively coupling the XR display device 202 to the computing platform 206.

In particular embodiments, the computing platform 206 may include, for example, a standalone host computing system, an on-board computer system integrated with the XR display device 202, a mobile device, or any other hardware platform that may be capable of providing extended reality content to the XR display device 202. In particular embodiments, the computing platform 206 may include, for example, a cloud-based computing architecture (including one or more servers 208 and data stores 210) suitable for hosting and servicing XR applications or experiences executing on the XR electronic device 202. For example, in particular embodiments, the computing platform 206 may include a Platform as a Service (PaaS) architecture, a Software as a Service (SaaS) architecture, and an Infrastructure as a Service (IaaS), or other similar cloud-based computing architecture.

### System Overview

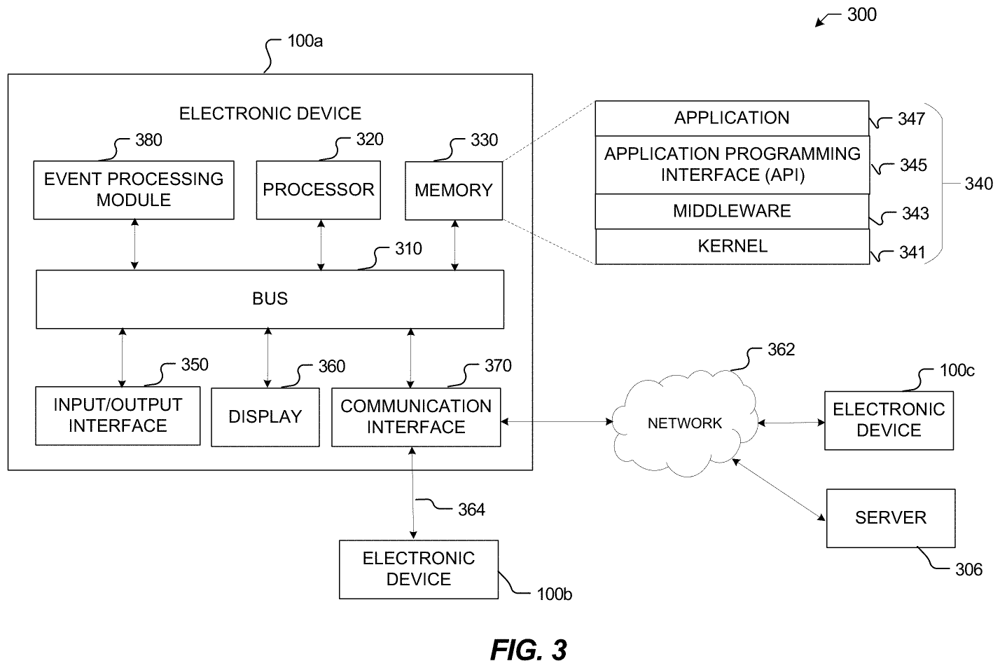

FIG. 3 illustrates an example network. Referring to FIG. 3, according to an embodiment of the present disclosure, an electronic device 100a may be included in a network environment 300. The electronic device 100a may include at least one of a bus 310, a processor 320, a memory 330, an input/output interface 350, a display 360, a communication interface 370, or an event processing module 380. In some embodiments, the electronic device 100a may exclude at least one of the components or may add another component.

The bus 310 may include a circuit for connecting the components 320 to 380 with one another and transferring communications (e.g., control messages and/or data) between the components.

The processing module 320 may include one or more of a central processing unit (CPU), an application processor (AP), or a communication processor (CP). The processor 320 may perform control on at least one of the other components of the electronic device 100a, and/or perform an operation or data processing relating to communication.

The memory 330 may include a volatile and/or non-volatile memory. For example, the memory 330 may store commands or data related to at least one other component of the electronic device 100a. According to an embodiment of the present disclosure, the memory 330 may store software and/or a program 340. The program 340 may include, e.g., a kernel 341, middleware 343, an application programming interface (API) 345, and/or an application program (or “application”) 347. At least a portion of the kernel 341, middleware 343, or API 345 may be denoted an operating system (OS).

For example, the kernel 341 may control or manage system resources (e.g., the bus 310, processor 320, or a memory 330) used to perform operations or functions implemented in other programs (e.g., the middleware 343, API 345, or application program 347). The kernel 341 may provide an interface that allows the middleware 343, the API 345, or the application 347 to access the individual components of the electronic device 100a to control or manage the system resources.

The middleware 343 may function as a relay to allow the API 345 or the application 347 to communicate data with the kernel 341, for example. A plurality of applications 347 may be provided. The middleware 343 may control work requests received from the applications 347, e.g., by allocation the priority of using the system resources of the electronic device 100a (e.g., the bus 310, the processor 320, or the memory 330) to at least one of the plurality of applications 347.

The API 345 may be an interface allowing the application 347 to control functions provided from the kernel 341 or the middleware 343. For example, the API 345 may include at least one interface or function (e.g., a command) for filing control, window control, image processing or text control.

The input/output interface 350 may serve as an interface that may, e.g., transfer commands or data input from a user or other external devices to other component(s) of the electronic device 100a. Further, the input/output interface 350 may output commands or data received from other component(s) of the electronic device 100a to the user or the other external device.

The display 360 may include, e.g., a liquid crystal display (LCD), a light emitting diode (LED) display, an organic light emitting diode (OLED) display, or a microelectromechanical systems (MEMS) display, or an electronic paper display. The display 360 may display, e.g., various contents (e.g., text, images, videos, icons, or symbols) to the user. The display 360 may include a touchscreen and may receive, e.g., a touch, gesture, proximity or hovering input using an electronic pen or a body portion of the user.

For example, the communication interface 370 may set up communication between the electronic device 100a and an external electronic device (e.g., a first electronic device 100b, a second electronic device 100c, or a server 306). For example, the communication interface 370 may be connected with the network 362 or 364 through wireless or wired communication to communicate with the external electronic device.

The first external electronic device 100b or the second external electronic device 100c may be a wearable device or an electronic device 100a—mountable wearable device (e.g., a head mounted display (HMD)). When the electronic device 100a is mounted in an HMD (e.g., the electronic device 100b), the electronic device 100a may detect the mounting in the HMD and operate in a virtual reality mode. When the electronic device 100a is mounted in the electronic device 100b (e.g., the HMD), the electronic device 100a may communicate with the electronic device 100b through the communication interface 370. The electronic device 100a may be directly connected with the electronic device 100b to communicate with the electronic device 100b without involving with a separate network.

The wireless communication may use at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. The wired connection may include at least one of universal serial bus (USB), high definition multimedia interface (HDMI), recommended standard 232 (RS-232), or plain old telephone service (POTS).

The network 362 may include at least one of communication networks, e.g., a computer network (e.g., local area network (LAN) or wide area network (WAN)), Internet, or a telephone network.

The first and second external electronic devices 100b and 100c each may be a device of the same or a different type from the electronic device 100a. According to an embodiment of the present disclosure, the server 306 may include a group of one or more servers. According to an embodiment of the present disclosure, all or some of operations executed on the electronic device 100a may be executed on another or multiple other electronic devices (e.g., the electronic devices 100b and 100c or server 306). According to an embodiment of the present disclosure, when the electronic device 100a should perform some function or service automatically or at a request, the electronic device 100a, instead of executing the function or service on its own or additionally, may request another device (e.g., electronic devices 100b and 100c or server 306) to perform at least some functions associated therewith. The other electronic device (e.g., electronic devices 100b and 100c or server 306) may execute the requested functions or additional functions and transfer a result of the execution to the electronic device 100a. The electronic device 100a may provide a requested function or service by processing the received result as it is or additionally. To that end, a cloud computing, distributed computing, or client-server computing technique may be used, for example.

Although FIG. 3 shows that the electronic device 100a includes the communication interface 370 to communicate with the external electronic device 100b or 100c via the network 362, the electronic device 100a may be independently operated without a separate communication function, according to an embodiment of the present invention.

The server 306 may support to drive the electronic device 100a by performing at least one of operations (or functions) implemented on the electronic device 100a. For example, the server 306 may include an event processing server module (not shown) that may support the event processing module 380 implemented in the electronic device 100a.

For example, the event processing server module may include at least one of the components of the event processing module 380 and perform (or instead perform) at least one of the operations (or functions) conducted by the event processing module 380.

The event processing module 380 may process at least part of information obtained from other elements (e.g., the processor 320, the memory 330, the input/output interface 350, or the communication interface 370) and may provide the same to the user in various manners.

Although in FIG. 3 the event processing module 380 is shown to be a module separate from the processor 320, at least a portion of the event processing module 380 may be included or implemented in the processor 320 or at least one other module, or the overall function of the event processing module 380 may be included or implemented in the processor 320 shown or another processor. The event processing module 380 may perform operations according to embodiments of the present invention in interoperation with at least one program 340 stored in the memory 330.

Exemplary embodiments described herein are not meant to be limiting and merely illustrative of various aspects of the invention. While exemplary embodiments may be indicated as applicable to a particular device category (e.g., head-mounted displays, etc.) the processes and examples provided are not intended to be solely limited to the device category and can be broadly applicable to various device categories (e.g., appliances, computers, automobiles, mobile phone, tablet, etc.).

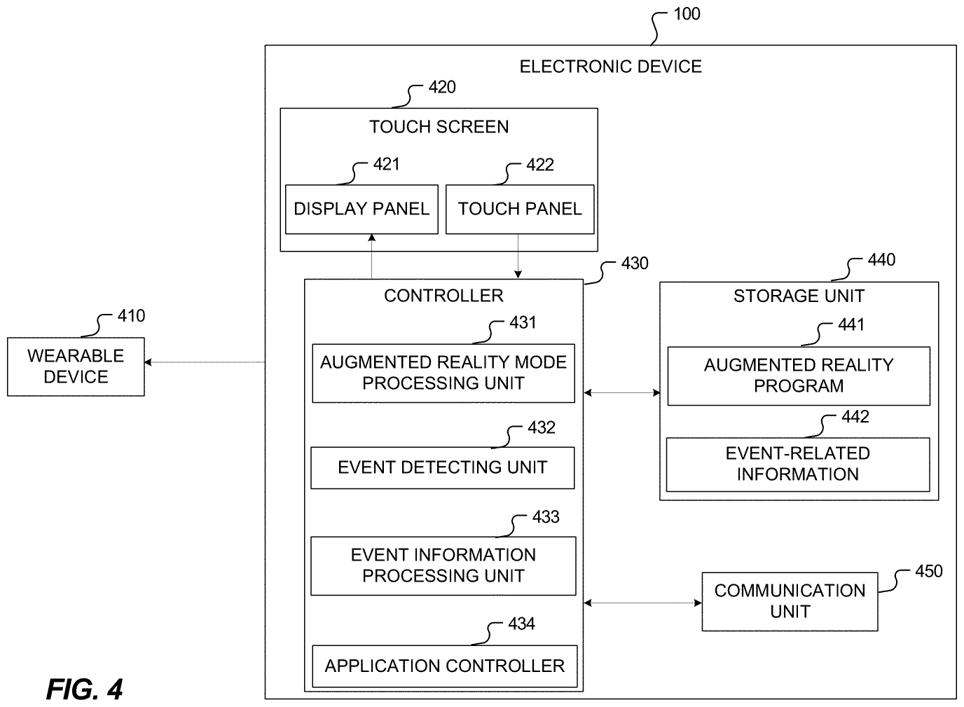

FIG. 4 illustrates an example block diagram of an example configuration of an electronic device. Referring to FIG. 4, the electronic device 100 according to an embodiment of the present invention may be an electronic device 100 having at least one display means. In the following description, the electronic device 100 may be a device primarily performing a display function or may denote a normal electronic device including at least one display means. For example, the electronic device 100 may be an electronic device (e.g., a smartphone) having a touchscreen 420.

According to an embodiment of the present invention, the electronic device 100 may include at least one of a touchscreen 420, a controller 430, a storage unit 440, or a communication unit 450. The touchscreen 420 may include a display panel 421 and/or a touch panel 422. The controller 430 may include at least one of an augmented reality mode processing unit 431, an event determining unit 432, an event information processing unit 433, or an application controller 434.

For example, when the electronic device 100 is mounted in a wearable device 410, the electronic device 100 may operate, e.g., as an HMD, and run an augmented reality mode. Further, according to an embodiment of the present invention, even when the electronic device 100 is not mounted in the wearable device 410, the electronic device 100 may run the augmented reality mode according to the user's settings or running an augmented reality mode related application. In the following embodiment, although the electronic device 100 is set to be mounted in the wearable device 410 to run the augmented reality mode, embodiments of the present invention are not limited thereto.

According to an embodiment of the present invention, when the electronic device 100 operates in the augmented reality mode (e.g., the electronic device 100 is mounted in the wearable device 410 to operate in a head mounted theater (HMT) mode), two screens corresponding to the user's eyes (left and right eye) may be displayed through the display panel 421.

According to an embodiment of the present invention, when the electronic device 100 is operated in the augmented reality mode, the controller 430 may perform control to process information related to an event generated while operating in the augmented reality mode to fit the augmented reality mode and display the processed information. According to an embodiment of the present invention, when the event generated while operating in the augmented reality mode is an event related to running an application, the controller 430 may block the running of the application or process the application to operate as a background process or application.

More specifically, according to an embodiment of the present invention, the controller 430 may include at least one of a augmented reality mode processing unit 431, an event determining unit 432, an event information processing unit 433, or an application controller 434 to perform functions according to various embodiments of the present invention. An embodiment of the present invention may be implemented to perform various operations or functions as described below using at least one component of the electronic device 100 (e.g., the touchscreen 420, controller 430, or storage unit 440).

According to an embodiment of the present invention, when the electronic device 100 is mounted in the wearable device 410 or the augmented reality mode is run according to the user's setting or as a augmented reality mode-related application runs, the augmented reality mode processing unit 431 may process various functions related to the operation of the augmented reality mode. The augmented reality mode processing unit 431 may load at least one augmented reality program 441 stored in the storage unit 440 to perform various functions.

The event determining unit 432 may determine an event generated while operated in the augmented reality mode by the augmented reality mode processing unit 431. Further, the event determining unit 432 may determine whether there is information to be displayed on the screen in relation with an event generated while operating in the augmented reality mode. Further, the event determining unit 432 may determine an application to be run in relation with an event generated while operating in the augmented reality mode. Various embodiments of an application related to the type of event are described below.

The event information processing unit 433 may process the event-related information to be displayed on the screen to fit the augmented reality mode when there is information to be displayed in relation with an event occurring while operating in the augmented reality mode depending on the result of determination by the event determining unit 432. Various methods for processing the event-related information may apply. For example, when a three-dimensional (3D) image is implemented in the augmented reality mode, the electronic device 100 may convert the event-related information to fit the 3D image. For example, event-related information being displayed in two dimension (2D) may be converted into information corresponding to the left and right eye corresponding to the 3D image, and the converted information may be synthesized and displayed on the screen of the augmented reality mode being currently run.

When it is determined by the event determining unit 432 that there is an application to be run in relation with the event occurring while operating in the augmented reality mode, the application controller 434 may perform control to block the running of the application related to the event. According to an embodiment of the present invention, when it is determined by the event determining unit 432 that there is an application to be run in relation with the event occurring while operating in the augmented reality mode, the application controller 434 may perform control so that the application is run in the background not to influence the running or screen display of the application corresponding to the augmented reality mode when the event-related application runs.

The storage unit 440 may store an augmented reality program 441. The augmented reality program 441 may be an application related to the augmented reality mode operation of the electronic device 100. The storage unit 440 may store the event-related information 442. The event determining unit 432 may reference the event-related information 442 stored in the storage unit 440 to determine whether the occurring event is displayed on the screen or identify information on the application to be run in relation with the occurring event.

The wearable device 410 may be an electronic device 100, and the wearable device 410 may be a wearable stand to which the electronic device 100 may be mounted. In case the wearable device 410 is an electronic device 100, when the electronic device 100 is mounted on the wearable device 410, various functions may be provided through the communication unit 450 of the electronic device 100. For example, when the electronic device 100 is mounted on the wearable device 410, the electronic device 100 may detect whether to be mounted on the wearable device 410 for communication with the wearable device 410 and may determine whether to operate in the augmented reality mode (or an HMT mode).

According to an embodiment of the present invention, upon failure to automatically determine whether the electronic device 100 is mounted when the communication unit is mounted on the wearable device 410, the user may apply various embodiments of the present invention by running the augmented reality program 441 or selecting the augmented reality mode (or, the HMT mode). According to an embodiment of the present invention, when the wearable device 410 includes functions as the electronic device 100, it may be implemented to automatically determine whether the electronic device 100 is mounted on the wearable device 410 and to enable the running mode of the electronic device 100 to automatically switch to the augmented reality mode (or the HMT mode).

At least some functions of the controller 430 shown in FIG. 4 may be included in the event processing module 380 or processor 320 of the electronic device 100a shown in FIG. 3. The touchscreen 420 or display panel 421 shown in FIG. 4 may correspond to the display 360 of FIG. 3. The storage unit 440 shown in FIG. 4 may correspond to the memory 330 of FIG. 3.

Although in FIG. 4 the touchscreen 420 includes the display panel 421 and the touch panel 422, according to an embodiment of the present invention, the display panel 421 or the touch panel 422 may also be provided as a separate panel rather than being in a single touchscreen 420. Further, according to an embodiment of the present invention, the electronic device 100 may include the display panel 421 but exclude the touch panel 422.

According to an embodiment of the present invention, the electronic device 100 may be denoted as a first device (or a first electronic device), and the wearable device 410 may be denoted as a second device (or a second electronic device) for ease of description.

According to an embodiment of the present invention, an electronic device may comprise a display unit displaying a screen corresponding to a augmented reality mode and a controller performing control to detect an interrupt according to occurrence of at least one event, vary event-related information related to the event in a form corresponding to the augmented reality mode, and display the varied event-related information on a screen run corresponding to the augmented reality mode.

According to an embodiment of the present invention, the event may include any one or more selected from among a call reception event, a message reception event, an alarm notification, a scheduler notification, a wireless fidelity (Wi-Fi) connection, a WiFi disconnection, a low battery notification, a data permission or use restriction notification, a no application response notification, or an abnormal application termination notification.

According to an embodiment of the present invention, the electronic device further comprises a storage unit storing the event-related information when the event is not an event to be displayed in the augmented reality mode, wherein the controller may perform control to display the event-related information stored in the storage unit when the electronic device switches from the augmented reality mode into a see-through mode.

According to an embodiment of the present invention, the electronic device may further comprise a storage unit storing information regarding at least one event to be displayed in the augmented reality mode.

According to an embodiment of the present invention, the event may include an instant message reception notification event.

According to an embodiment of the present invention, when the event is an event related to running at least one application, the controller may perform control to block running of the application according to occurrence of the event.

According to an embodiment of the present invention, the controller may perform control to run the blocked application when a screen mode of the electronic device switches from the augmented reality mode into a see-through mode.

According to an embodiment of the present invention, when the event is an event related to running at least one application, the controller may perform control to enable the application according to the occurrence of the event to be run on a background of a screen of the augmented reality mode.

According to an embodiment of the present invention, when the electronic device is connected with a wearable device, the controller may perform control to run the augmented reality mode.

According to an embodiment of the present invention, the controller may enable the event-related information to be arranged and processed to be displayed in a three-dimensional (3D) space of the augmented reality mode screen being displayed on a current screen.

According to an embodiment of the present invention, the electronic device may include additional sensors such as one or more RGB cameras, DVS cameras, 360-degree cameras, or a combination thereof.

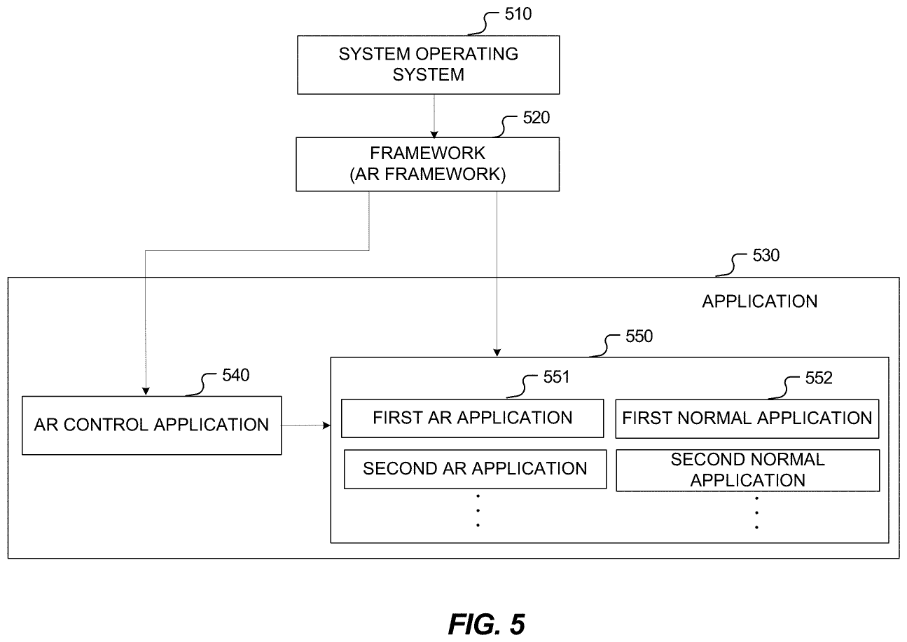

FIG. 5 illustrates an example block diagram of a program module. Referring to FIG. 5, according to an embodiment of the present invention, the program module may include a system operating system (e.g., an OS) 510, a framework 520, an application 530.

The system operating system 510 may include at least one system resource manager or at least one device driver. The system resource manager may perform, e.g., control, allocation, or recovery of system resources, and the system resource manager may include at least one manager, such as a process manager, a memory manager, or a file system manager. The device driver may include at least one driver, such as, e.g., a display driver, a camera driver, a Bluetooth driver, a shared memory driver, a USB driver, a keypad driver, a Wi-Fi driver, an audio driver, or an inter-process communication (IPC) driver.

According to an embodiment of the present invention, the framework 520 (e.g., middleware) may provide, e.g., functions commonly required for the application or provide the application with various functions through the API to allow the application to efficiently use limited system resources inside the electronic device.

According to an embodiment of the present invention, the AR framework included in the framework 520 may control functions related to augmented reality mode operations on the electronic device. For example, according to running of an augmented reality mode operation, the AR framework 520 may control at least one AR application 551 related to augmented reality among applications 530 to provide the augmented reality mode on the electronic device.

The application 530 may include a plurality of applications and may include at least one AR application 551 running in the augmented reality mode and at least one normal application 552 running in a normal mode, but not the augmented reality mode.

According to an embodiment of the present invention, the application 530 may further include an AR control application 540. An operation of the at least one AR application 551 and/or at least one normal application 552 may be controlled under the control of the AR control application 540.

According to an embodiment of the present invention, when at least one event occurs while the electronic device operates in the augmented reality mode, the system operating system 510 may notify the framework 520 (e.g., the AR framework) of occurrence of the event.

The framework 520 may control the running of the normal application 552 so that event-related information may be displayed on the screen for the event occurring in the normal mode, but not in the augmented reality mode. When there is an application to be run in relation with the event occurring in the normal mode, the framework 520 may perform control to run at least one normal application 552.

According to an embodiment of the present invention, when an event occurs while operating in the augmented reality mode, the framework 520 (e.g., the AR framework) may block the operation of at least one normal application 552 to display the information related to the occurring event. The framework 520 may provide the event occurring while operating in the augmented reality mode to the AR control application 540.

The AR control application 540 may process the information related to the event occurring while operating in the augmented reality mode to fit the augmented reality mode. For example, 2D, planar event-related information may be processed into 5D information.

The AR control application 540 may control at least one AR application 551 currently running and may perform control to synthesize the processed event-related information with the running screen by the AR application 551 and display the result.

According to an embodiment of the present invention, when an event occurs while operating in the augmented reality mode, the framework 520 may perform control to block the running of at least one normal application 552 related to the occurring event.

According to an embodiment of the present invention, when an event occurs while operating in the augmented reality mode, the framework 520 may perform control to temporarily block the running of at least one normal application 552 related to the occurring event, and when the augmented reality mode terminates, to run the blocked normal application 552.

According to an embodiment of the present invention, when an event occurs while operating in the augmented reality mode, the framework 520 may control the running of at least one normal application 552 related to the occurring event so that the at least one normal application 552 related to the event operates on the background so as not to influence the screen by the AR application 551 currently running.

The embodiment described in connection with FIG. 5 is an example for implementing an embodiment of the present invention in the form of a program, and embodiments of the present invention are not limited thereto and rather may be implemented in other various forms. Further, while the embodiment described in connection with FIG. 5 references AR, it may be applied to other scenarios such as virtual reality, mixed reality, etc. In such embodiments, the AR portions or components may be utilized to enable the virtual reality or mixed reality aspects. Collectively the various reality scenarios may be referenced herein as XR.

### Manipulating Views and Shared Objects in XR Space

An XR video call may require more settings and controls for a phone user than the traditional video call. In an XR video call, both phone users and users of head mounted XR devices (e.g., AR glasses) may be able to share XR objects. Transformation of a shared 2D/3D XR object on a 2D touchscreen display may show on-screen UI such as bounding boxes, handles, buttons, and gizmos. Furthermore, in the XR video call, the phone user may move the camera around for view manipulation. Those multiple controls may cause the clutter problem on the phone screen and complex touch gestures. To address the aforementioned problems, the embodiments disclosed herein use multitouch gesture interpretation to enable users to easily share and transform XR objects in an XR video call.

In particular embodiments, an electronic device 100 may enable a user of the electronic device 100 to easily view a representation of a shared extended reality (XR) object or manipulate the object via a variety of gesture inputs in an XR space during an XR video call. As an example and not by way of limitation, the electronic device 100 may comprise a two-dimensional (2D) mobile device (e.g., mobile phone, tablet, etc.). The XR video call may be between the user of the electronic device 100 and other user(s) using head mounted XR devices. In the XR video call, all users may share XR objects comprising images, videos, 3D objects, and their physical environments. After sharing the XR objects, transforming (e.g., positioning, rotating, and scaling) a 3D object through a 2D touchscreen interface and a 2D object in a 3D environment may be a task with inherent complexity that typically requires on-screen user interface (UI), such as bounding boxes, handles, buttons, gizmos. This complexity may compound when these same touch gestures also allow the user to reposition the view of the camera on the electronic device 100. To address this complex task, the embodiments disclosed herein effectively interpret multitouch gestures to enable different object transformations (e.g., translation, rotation, scaling) and different view transformations (e.g., translation, rotation, zooming) without the need for visible UI or mode switching, which may be a technical advantage of the embodiments disclosed herein. The embodiments disclosed herein may use “zooming” and “scaling” interchangeably. As an example and not by way of limitation, zooming in/out the view may be translating the user's view forward or backward, which enables the user to zoom in their view/virtual-camera (changing the field of view). As another example and not by way of limitation, zooming an object may be scaling it up or down, e.g., scaling a user's representation in the XR video call up or down. The embodiments disclosed herein also disclose a media sharing flow with simple touch gestures. Media sharing flow may change based on the number of participants in the XR video call. The gestures may reflect the user's intents whether they want to share a single media object or multiple media objects to collaborate with other users. The embodiments disclosed herein also provide additional touch controls to a user in a call space to help improve manipulation experience for a shared workspace.

In particular embodiments, the electronic device 100 may render, on the one or more touchscreen displays, a first sequence of image frames of an extended reality (XR) video call. The first sequence of images may portray a shared XR space. In particular embodiments, the XR video call may be between a first user of the electronic device 100 and one or more second users. The electronic device 100 may then receive, via the one or more touchscreen displays, one or more gesture inputs associated with manipulating one or more parameters of the XR space during the XR video call. In particular embodiments, the electronic device 100 may determine, responsive to the one or more gesture inputs, one or more transformations within the XR space. The determination may be based on a gesture type associated with each of the one or more gesture inputs. In particular embodiments, the electronic device 100 may further render, on the one or more touchscreen displays, a second sequence of image frames of the XR video call. The second sequence of images may portray the one or more transformations to the XR space.

Certain technical challenges exist for manipulating parameters of an XR space during an XR video call. One technical challenge may include responding to user's manipulations by accurately transforming the XR space. The solution presented by the embodiments disclosed herein to address this challenge may be determining whether the user's gesture inputs are intended to manipulate an XR object or a view of the XR space based on the gesture type of each gesture input as each distinct gesture type corresponds to a particular user intent and a particular transformation of the XR space.

Certain embodiments disclosed herein may provide one or more technical advantages. A technical advantage of the embodiments may include enabling object manipulations and view manipulations without the need for visible UI or mode-switching. Another technical advantage of the embodiments may include a user interface allowing both 2D (e.g., mobile phone, tablet, etc.) and 3D (e.g., head mounted XR devices, etc.) users to browse for, and import, media (e.g., photos, videos, 3D objects, etc.) into the shared virtual space of the XR video call. Another technical advantage of the embodiments may include an easy media sharing flow with simple touch gestures, which reflect the user's intent whether they want to share a single media or multiple media to collaborate with other users. Another technical advantage of the embodiments may include additional touch control to help better manipulation experience for shared workspace when the user is on a group XR video call. Certain embodiments disclosed herein may provide none, some, or all of the above technical advantages. One or more other technical advantages may be readily apparent to one skilled in the art in view of the figures, descriptions, and claims of the present disclosure.

In particular embodiments, manipulating the parameters of the XR space by the user may cause one or more transformations (changes) to the XR space. Determining the one or more transformations may comprise determining, based on the gesture type associated with each of the one or more gesture inputs, whether the one or more gesture inputs are intended to manipulate an XR object or a view of the XR space. Determining whether the user's gesture inputs are intended to manipulate an XR object or a view of the XR space based on the gesture type of each gesture input may be an effective solution for addressing the technical challenge of responding to user's manipulations by accurately transforming the XR space as each distinct gesture type corresponds to a particular user intent and a particular transformation of the XR space. In particular embodiments, manipulating the one or more parameters of the XR space may comprise manipulating one or more XR objects in the XR space. Correspondingly, manipulating the one or more XR objects may comprise one or more of adding the one or more XR objects to the XR space, removing the one or more XR objects from the XR space, translating the one or more media objects, rotating the one or more XR objects, zooming in the one or more XR objects, or zooming out the one or more XR objects.

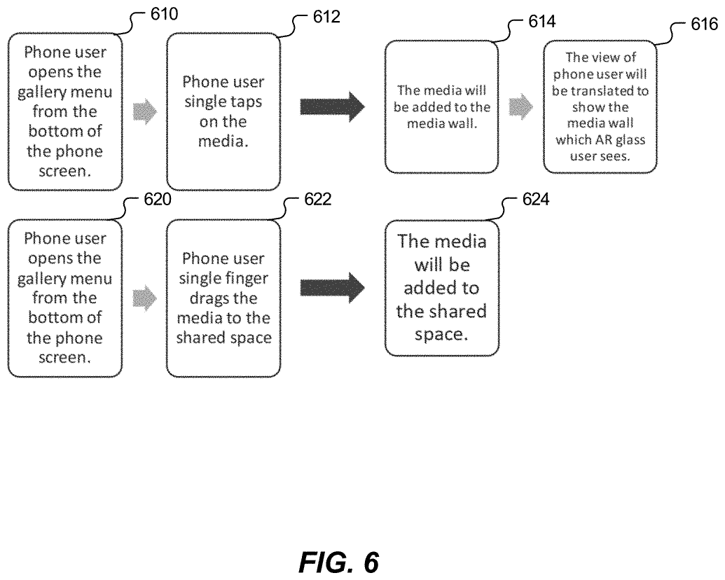

FIG. 6 illustrates example flow diagrams for sharing media content from an electronic device 100 in an XR video call. As an example and not by way of limitation, the electronic device 100 may be a smart phone and the other users in the XR video call may be using AR glasses. In particular embodiments, the user may share media content either to a media wall or the shared space. In FIG. 6, the top row illustrates the flow diagram for sharing media content to the media wall. At step 610, the phone user may open the gallery menu from the bottom of the phone screen. At step 612, the phone user may tap on the media with a single finger. At step 614, the media may be added to the media wall. At step 616, the view of the phone user may be translated to show the media wall which the AR-glass user sees. In FIG. 6, the bottom row illustrates the flow diagram for sharing media content to the shared space. At step 620, the phone user may open the gallery menu from the bottom of the phone screen. At step 622, the phone user may drag the media with a single finger to the shared space. At step 624, the media may be added to the shared space.

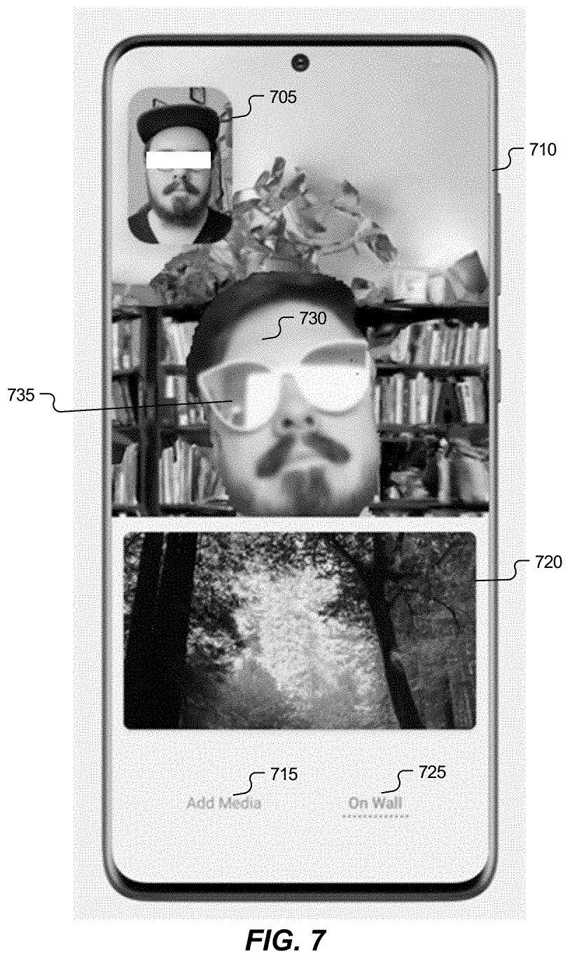

FIG. 7 illustrates an example user interface for sharing media content to the media wall. In particular embodiments, the structure of the interface may comprise a media wall, on which the user may choose the media to share from the gallery. When the user taps the media with a single finger, the media may be shared on the media wall. The structure of the interface may also comprise a wall menu. Tapping the wall menu may allow a phone user to see a selected media object together with a user of AR glasses. As illustrated in FIG. 7, user 705, who uses a smart phone 710, may start at the root of the user interface. User 705 may open a wall share sheet, which may be a default view the user 705 may see. The default view may be different from the first time the user 705 selected it and subsequent times. User 705 may tap on “add media” 715, which may show media content from the user's 705 phone gallery. User 705 may further tap a media content from the gallery to share it to the wall in the XR video call. The option “on wall” 725 may shows what media content is already on the shared wall. As illustrated in FIG. 7, the image or video of trees 720 is already on the wall.

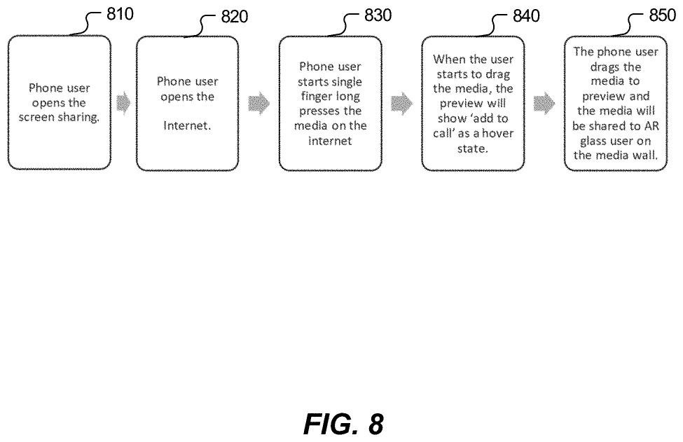

FIG. 8 illustrates an example flow diagram for sharing media content from the Internet. As an example and not by way of limitation, the electronic device 100 may be a smart phone and the other users in the XR video call may be using AR glasses. At step 810, the phone user may open the screen sharing from the phone. At step 820, the phone user may open the Internet. At step 830, the phone user may start long presses of the media on the Internet with a single finger. At step 840, when the user starts to drag the media, the preview may show “add to call” as a hover state. At step 850, the phone user may drag the media to preview and the media may be shared to AR-glass user on the media wall.

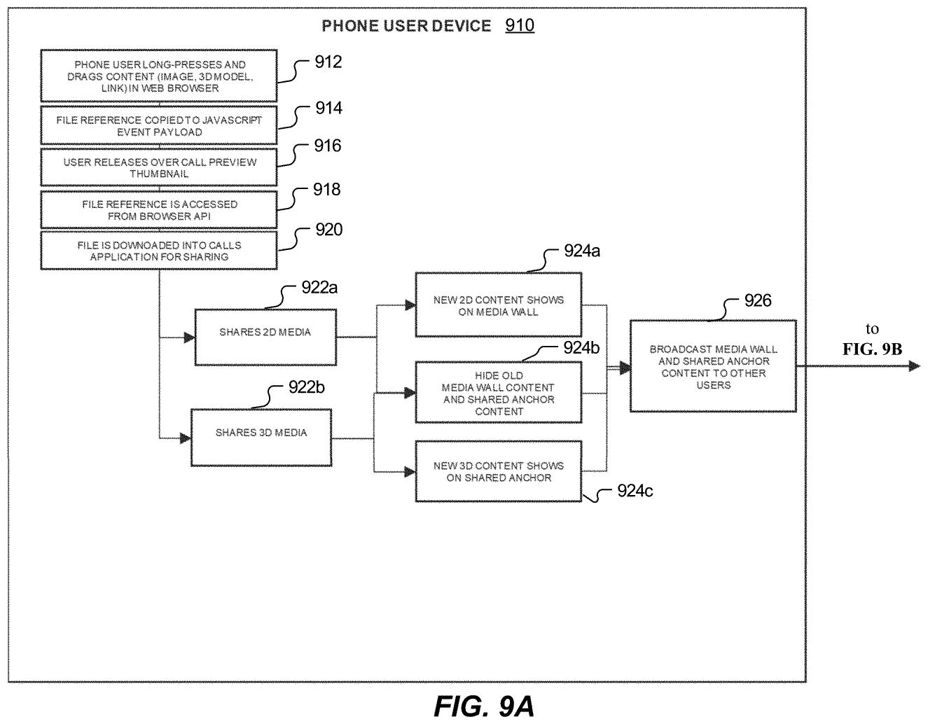

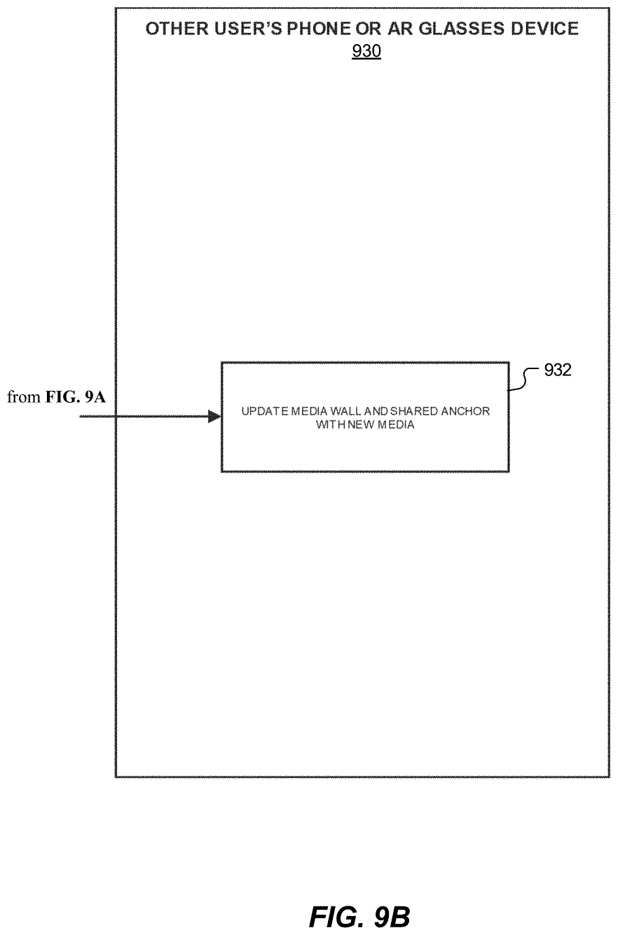

FIG. 9A illustrates an example flow diagram for sharing the media on the media wall with a long press using a single finger with respect to the phone user device. With respect to the phone user device 910 at step 912, the phone user may long-press and drag content (e.g., image, 3D model, link, etc.) in web browser. At step 914, the file reference may be copied to Java script event payload. At step 916, the user may release over call preview thumbnail. At step 918, the file reference may be accessed from browser API. At step 920, the file may be downloaded into calls application for sharing. After step 920, there may be different flows depending on what media content is shared. If at step 922a, the user shares a 2D media content, the new 2D media content may show on the media wall at step 924a. Meanwhile at step 924b, the electronic device 100 may hide old media wall content and shared anchor content. If at step 922b, the user shares a 3D media content, the new 3D media content may show on the shared anchor at step 924c. Meanwhile at step 924b, the electronic device 100 may hide old media wall content and shared anchor content. After the new 2D/3D media content shows on the media wall, the electronic device 100 may broadcast the media wall and shared anchor content to other users at step 926. After step 926, the example flow diagram continues to FIG. 9B. FIG. 9B illustrates the example flow diagram for sharing the media on the media wall with a tap using a single finger with respect to other user's phone or AR glasses device. The broadcast of the media wall and shared anchor content at step 926 in FIG. 9A may be provided to other user's phone or AR glasses device 930. At step 932, the other user's phone or AR glasses device 930 may update media wall and shared anchor with the new media content. As can be seen, the embodiments disclosed herein may have a technical advantage of an easy media sharing flow with simple touch gestures, which reflect the user's intent whether they want to share a single media or multiple media to collaborate with other users.

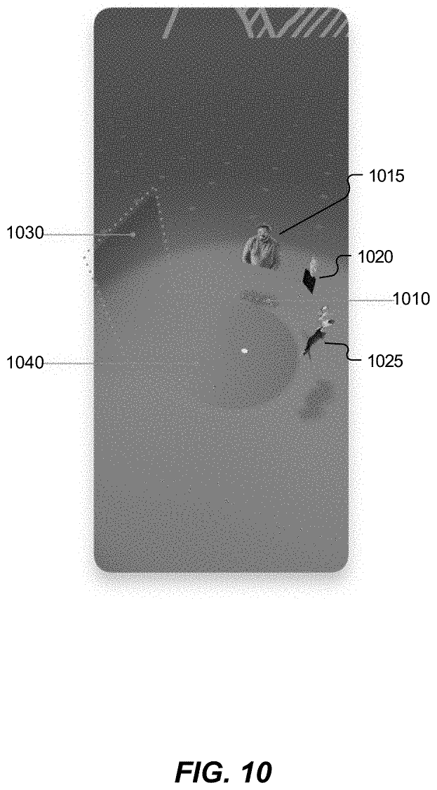

FIG. 10 illustrates an example shared XR space viewed on a phone user's screen. In particular embodiments, a user interface of the electronic device 100 may allow both 2D (e.g., mobile phone, etc.) and 3D (e.g., AR glasses, etc.) users to browse for, and import, media (e.g., photos, videos, 3D objects, etc.) into the shared XR space 1010 (i.e., a virtual scene) of the XR video call. In particular embodiments, the XR space 1010 may be a workspace where content is shared. The XR space 1010 may stay in synchronization across all users, e.g., user 1015, user 1020, and user 1025 as illustrated in FIG. 10. In particular embodiments, the XR space 1010 may be algorithmically positioned between users when the first objects are shared. The XR space 1010 may comprise one or more of a wall anchor 1030 for two-dimensional XR objects or a space anchor 1040 for three-dimensional XR objects. In particular embodiments, the wall anchor 1030 may be used to share 2D content and may be positioned at one end of the shared XR space 1010 for visibility. The space anchor 1040 may be used to share 3D content with a nib that points to the wall anchor 1030. As can be seen, the embodiments disclosed herein may have a technical advantage of a user interface allowing both 2D (e.g., mobile phone, tablet, etc.) and 3D (e.g., head mounted XR devices, etc.) users to browse for, and import, media (e.g., photos, videos, 3D objects, etc.) into the shared virtual space of the XR video call.

In particular embodiments, for the shared XR space, two touch gestures may tell the user's intent when sharing the media content. Tapping may allow the user to share a single media content from the user's electronic device 100 (e.g., phone), which may replace the previous shared media content. Dragging with one single finger may allow the user to add the media content to the XR space with other media content being the XR space at the same time.

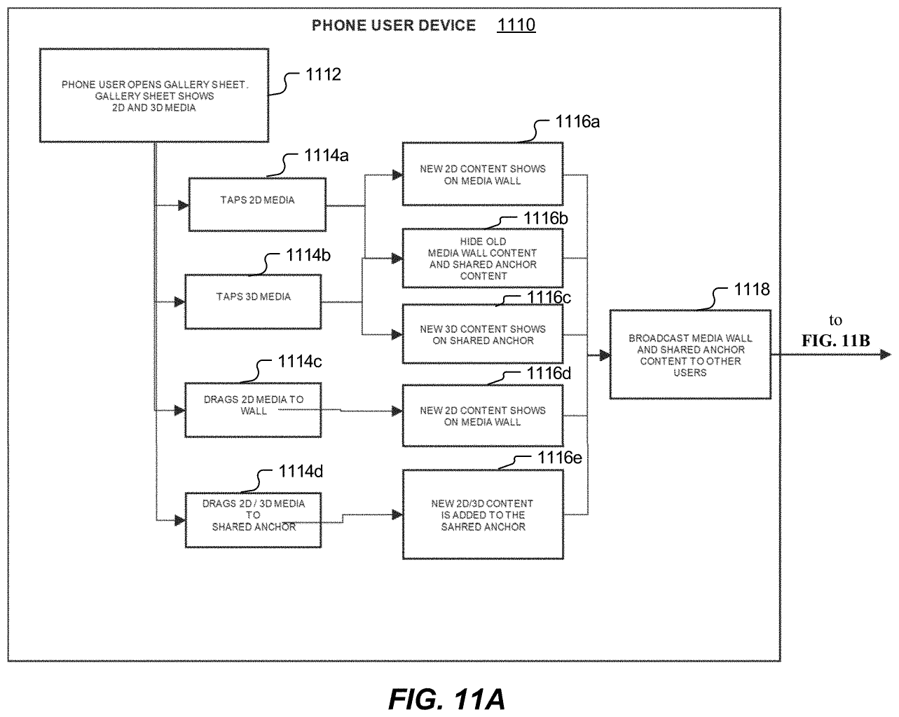

FIG. 11A illustrates an example diagram flow for sharing media content using a tap and drag with a single finger with respect to the phone user device. With respect to the phone user device 1110 at step 1112, the phone user may open the gallery sheet. The gallery sheet may show 2D and 3D media content. Depending on the type of the gesture inputs and the type of the media content, there may be different subsequent processes. If the user taps on a 2D media content at step 1114a, the new 2D media content may be shown on the media wall at step 1116a. Meanwhile, the electronic device 100 may hide the old media wall content and shared anchor content at step 1116b. If the user taps on a 3D media content at step 1114b, the new 3D media content may be shown on the shared anchor at step 1116c. Meanwhile, the electronic device 100 may hide the old media wall content and shared anchor content at step 1116b. If the user drags the 2D media content to the media wall at step 1114c, the new 2D media content may be shown on the media wall at step 1116d. If the user drags the 2D/3D media content to the shared anchor at step 1114d, the new 2D/3D media content may be added to the shared anchor at step 1116e. Then at step 1118, the electronic device 100 may broadcast the media wall and shared anchor content to other users. After step 1118, the example flow diagram continues to FIG. 11B. FIG. 11B illustrates the example flow diagram for sharing media content using a tap and drag with a single finger with respect to other user's phone or AR glasses device. The broadcast of the media wall and shared anchor content at step 1118 in FIG. 11A may be provided to other user's phone or AR glasses device 1120. At step 1122, the other user's phone or AR glasses device 1120 may update media wall and shared anchor with the new media content.

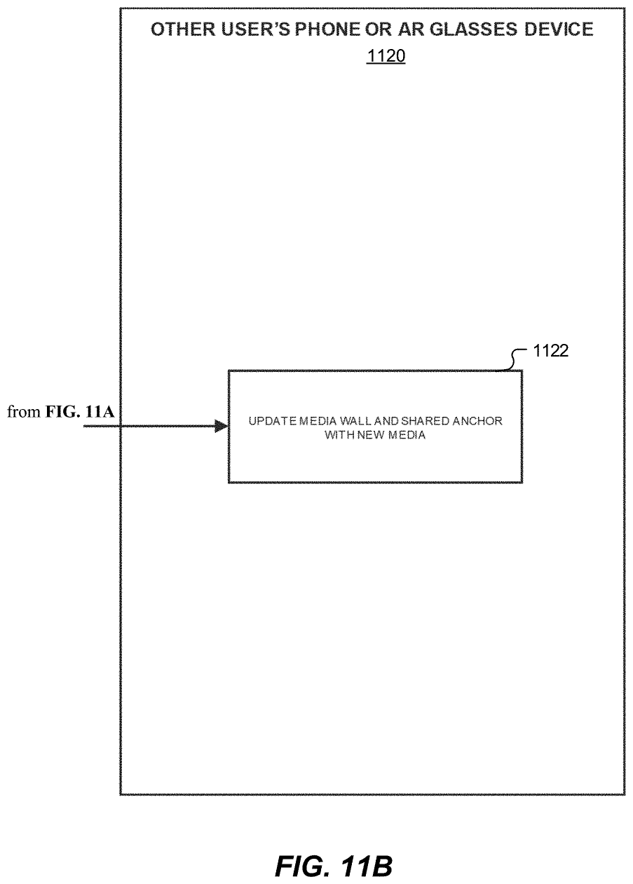

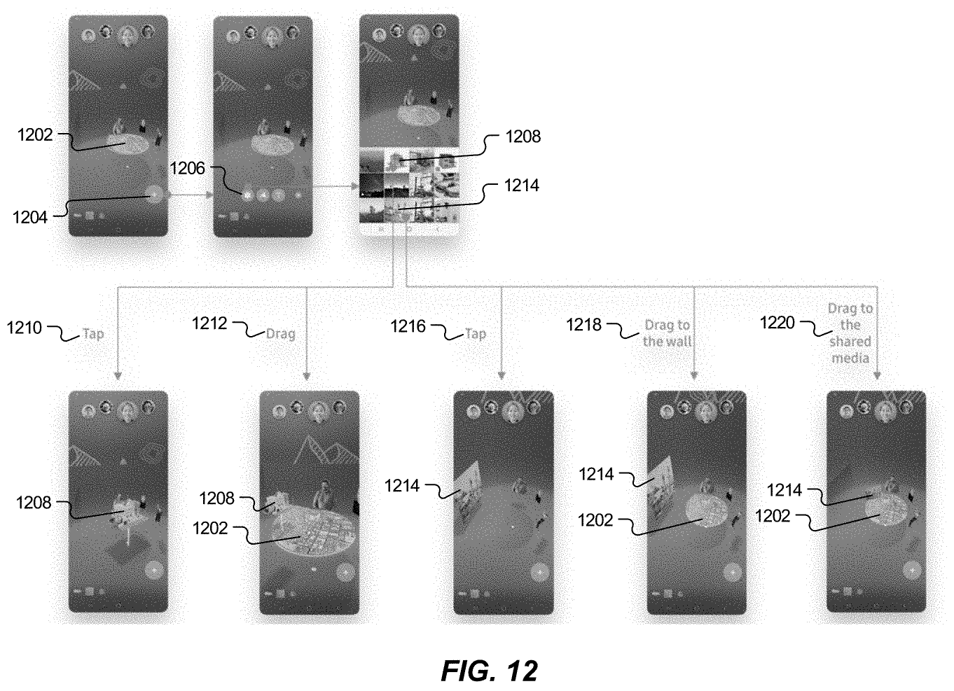

FIG. 12 illustrates example gesture inputs and corresponding media sharing processes. As illustrated in FIG. 12, a user may be in a group XR video call with other users. There may be a first shared media content 1202 already in the shared XR space. The first shared media content 1202 may be a 3D XR object, for which it may be at the space anchor. The user may tap on an “add” button 1204 to start the media sharing process. Then the user may select the source of the media content, e.g., by tapping on the “gallery” button 1206. The user may want to share a second media content 1208, which may be a 3D XR object. Based on the gesture input and the fact that the second media content 1208 is a 3D XR object, there may be different sharing flows. If the user taps 1210 on the second media content 1208 with a single finger, the second media content 1208 may be shared to the space anchor of the XR space, which may also replace the previously shared first media content 1202. If the user drags 1212 the second media content 1208 with a single finger to the XR space, the second media content 1208 may be added to the space anchor with the first media content 1202 coexisting. The user may alternatively want to share a third media content 1214, which may be a 2D XR object. Based on the gesture input and the fact that the third media content 1214 is a 2D XR object, there may be different sharing flows. If the user taps 1216 on the third media content 1214 with a single finger, the third media content 1214 may be added to the media wall of the XR space, which may also replace the previously shared first media content 1202 by removing it from the space anchor. If the user drags 1218 the third media content 1214 with a single finger to the wall anchor of the XR space, the third media content 1214 may be added to the wall anchor with the first media content 1202 at the space anchor. If the user drags 1220 the third media content 1214 with a single finger to the first media content 1202, the third media content 1214 may be added to the previously shared first media content 1202 at the space anchor. As a result, the embodiments disclosed herein may have a technical advantage of additional touch control to help better manipulation experience for shared workspace when the user is on a group XR video call.

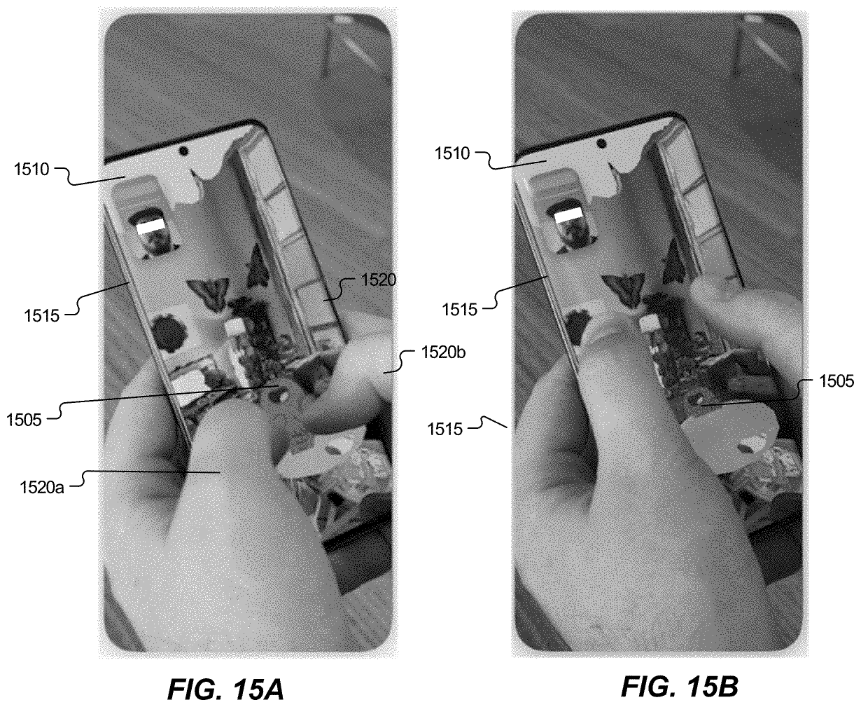

In particular embodiments, the user may use different types of gesture inputs to manipulate objects. As an example and not by way of limitation, the user may drag an XR object with a single finger, which may translate the XR object along plane parallel to the touchscreen of the electronic device 100. As another example and not by way of limitation, the user may rotate the XR object using two fingers. As yet another example and not by way of limitation, the user may pinch the XR object with two fingers to translate the XR object away/toward the touchscreen normal with two-finger drag up or down without pre-pinch. As yet another example and not by way of limitation, the user may drag the XR object with two fingers to transform the XR object along the plane parallel to the touchscreen. In particular embodiments, there may be a threshold the user has to cross for the electronic device 100 to determine if it should manipulate the object as a two-finger forward/backward translation or a two-finger translation along a plane parallel to the screen, followed by rotation and scaling. If the two fingers are about the same distance from each other in this threshold and if the two fingers are moving in about the same direction and if that direction is almost entirely up or almost entirely down, the forward/backward translation from their view happens with their gesture (e.g., as illustrated in FIGS. 15A-15B). If any of those criteria are absent, the electronic device may perform the combination of translation along a plane parallel to the screen, rotation, and scaling.

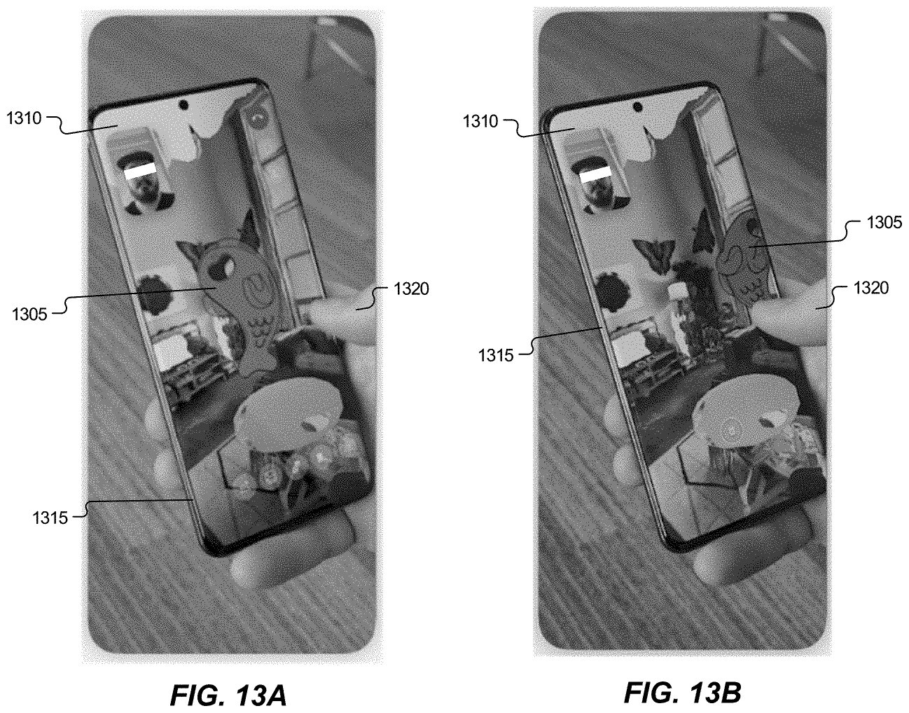

FIGS. 13A-13B illustrate an example manipulation of an XR object by dragging it with a single finger. FIG. 13A illustrate an example XR object in the XR space in an XR video call. As can be seen, the XR object 1305 may be a cartoon fish shown on the touchscreen 1310 of the phone 1315. The user may use a single finger 1320 to drag it. FIG. 13B illustrate an example manipulation of the XR object by dragging it with a single finger. As indicated in FIG. 13B, the user may use the single finger 1320 to drag the XR object 1305, which may result in the XR object 1305 being translated along the plane parallel to the touchscreen 1320 of the phone 1315.

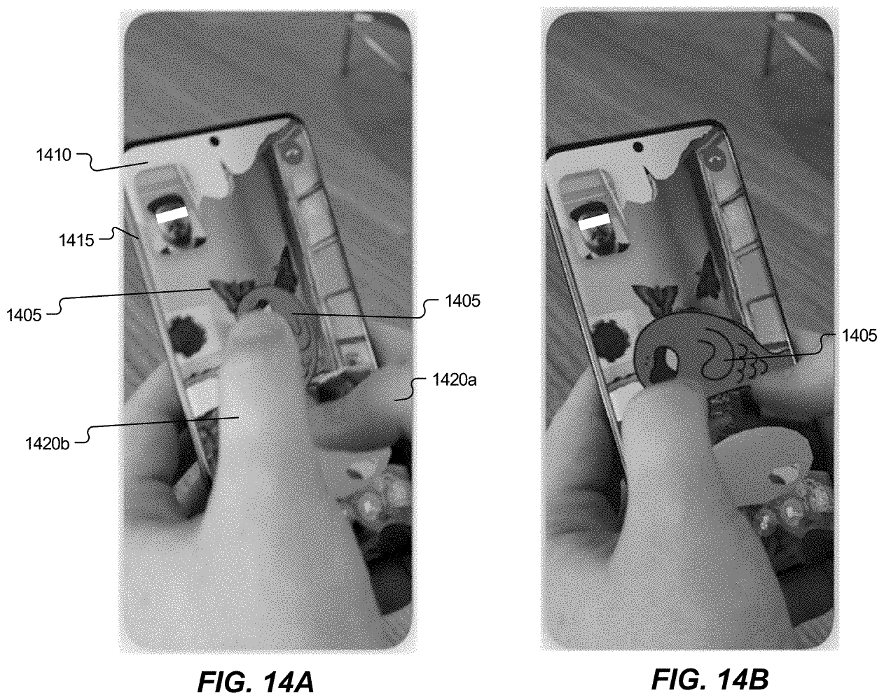

FIGS. 14A-14B illustrate an example manipulation of an XR object by rotating it with two fingers. FIG. 14A illustrate an example XR object in the XR space in an XR video call. As can be seen, the XR object 1405 may be a cartoon fish shown on the touchscreen 1410 of the phone 1415. The user may use two fingers 1420a/b to rotate it. FIG. 14B illustrate an example rotated XR object. As indicated in FIG. 14B, the XR object 1405 may have been rotated.

FIGS. 15A-15B illustrate an example manipulation of an XR object by dragging it with two fingers. FIG. 15A illustrate another example XR object in the XR space in an XR video call. As can be seen, the XR object 1505 may be a cartoon fish shown on the touchscreen 1510 of the phone 1515. The user may use two fingers 1520a/b to drag it. FIG. 15B illustrate an example manipulation of the XR object by dragging it with two fingers. As indicated in FIG. 15B, the XR object 1505 may have been translated away from the user, along a line orthogonal to the user's view. As discussed above, there may be a threshold the user has to cross for the electronic device 100 to determine if it should manipulate the object as a two-finger forward/backward translation or a two-finger translation along a plane parallel to the screen, followed by rotation and scaling. If the two fingers are about the same distance from each other in this threshold and if the two fingers are moving in about the same direction and if that direction is almost entirely up or almost entirely down, the forward/backward translation from their view happens with their gesture. If any of those criteria are absent, the electronic device may perform the combination of translation along a plane parallel to the screen, rotation, and scaling, as illustrated in FIG. 15B.

In particular embodiments, manipulating the one or more parameters of the XR space may comprise manipulating a view of the XR space. Correspondingly, manipulating the view of the XR space may comprise one or more of translating the view of the XR space, rotating the view of the XR space, zooming in the view of the XR space, or zooming out the view of the XR space. As an example and not by way of limitation, the user may double-tap the view with a single finger to translate forward toward the point, i.e., zooming in the view. As another example and not by way of limitation, the user may drag the view with a single finger to rotate the view around the center of orbit position. In particular embodiments, the orbit position may be set from a ray from the center of the camera to its intersection with an object in the scene. The orbit position may update on translate. As yet another example and not by way of limitation, the user may use two fingers to pinch the view to translate forward (i.e., zooming in) with pinch out. As yet another example and not by way of limitation, the user may use two fingers to pinch the view to translate backward (i.e., zooming out) with pinch in respectively. As yet another example and not by way of limitation, the user may drag the view with two fingers to translate the view along the camera plane.

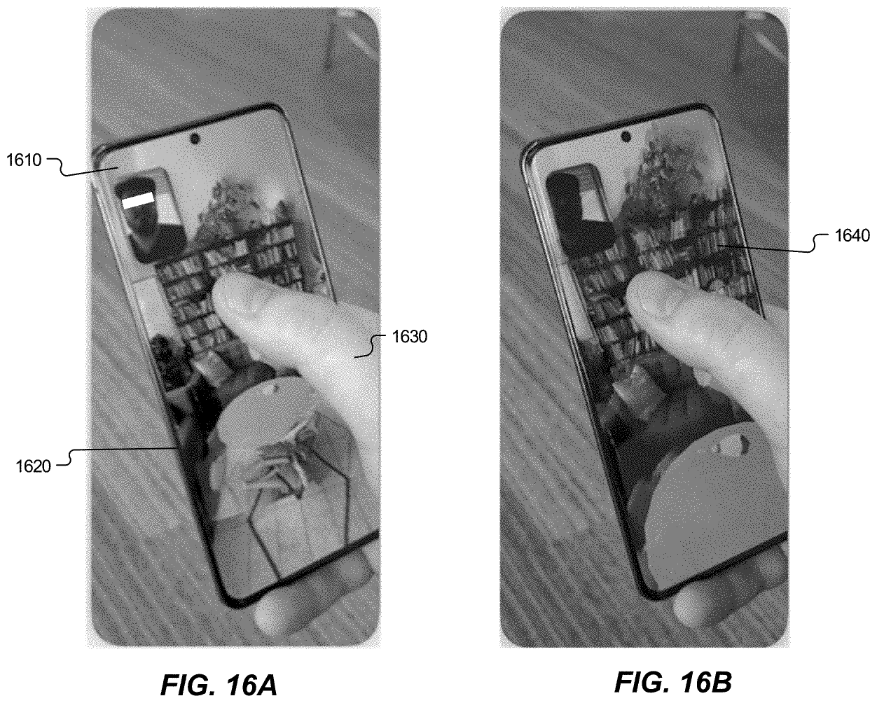

FIGS. 16A-16B illustrate an example manipulation of the view by double tapping it with a single finger. FIG. 16A illustrate an example view in an XR video call. As can be seen, the view may comprise a living room, which may be displayed on the touchscreen 1610 of the phone 1620. The user may use a single finger 1630 to double-tap the view. FIG. 16B illustrate an example manipulation of the view by double tapping it with a single finger. As indicated in FIG. 16B, the view may have been translated forward toward the point, i.e., zooming in. For example, the bookshelf 1640 looks bigger.

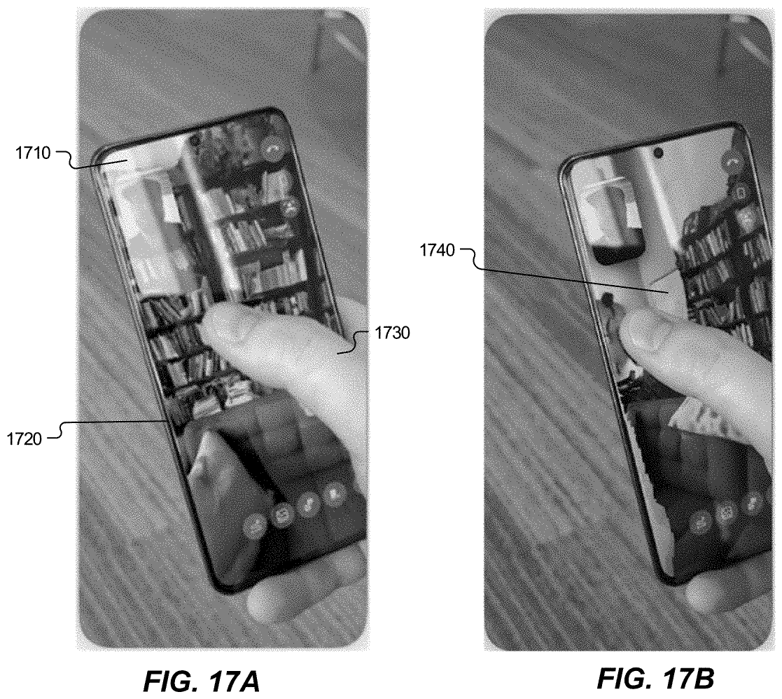

FIGS. 17A-17B illustrate an example manipulation of the view by dragging it with a single finger. FIG. 17A illustrate another example view in an XR video call. As can be seen, the view may comprise a living room, which may be displayed on the touchscreen 1710 of the electronic phone 1720. The user may use a single finger 1730 to drag the view. FIG. 17B illustrate an example manipulation of the view by dragging it with a single finger. As indicated in FIG. 17B, the view may have been rotated around the orbit position. For example, the user may have dragged it toward right, which shows a whiteboard 1740 that was not shown before in FIG. 17A.

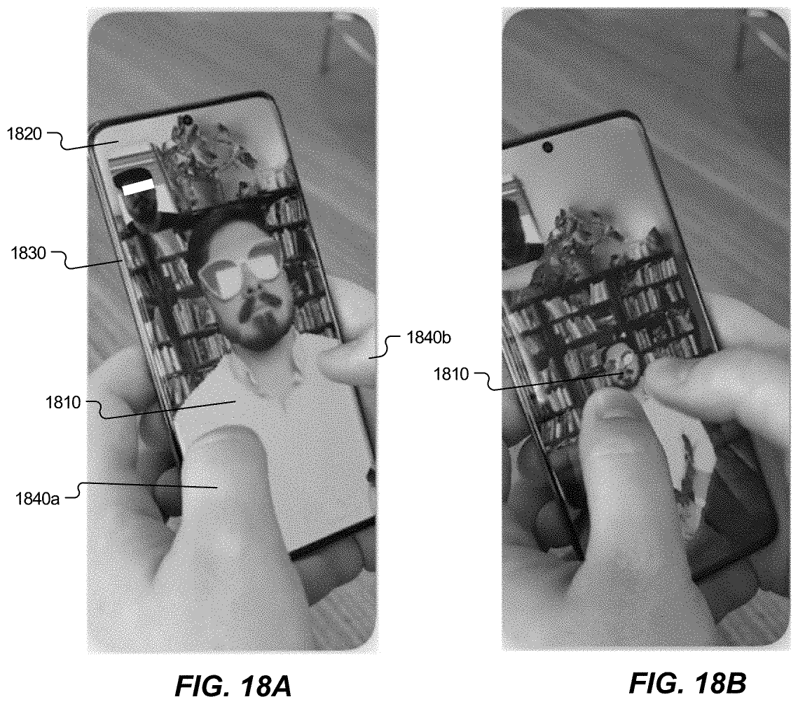

FIGS. 18A-18B illustrate an example manipulation of the view by pinching it with two fingers. FIG. 18A illustrate another example view in an XR video call. As can be seen, the view may comprise a living room and another user 1810 in the living room, which may be displayed on the touchscreen 1820 of the phone 1830. The user may use two fingers 1840a/b to pinch the view. FIG. 18B illustrate an example manipulation of the view by pinching it with two fingers. As indicated in FIG. 18B, the view may have been translated backward (i.e., zooming out) with pinch in. For example, the representation of user 1810 may become smaller as compared to FIG. 18A.

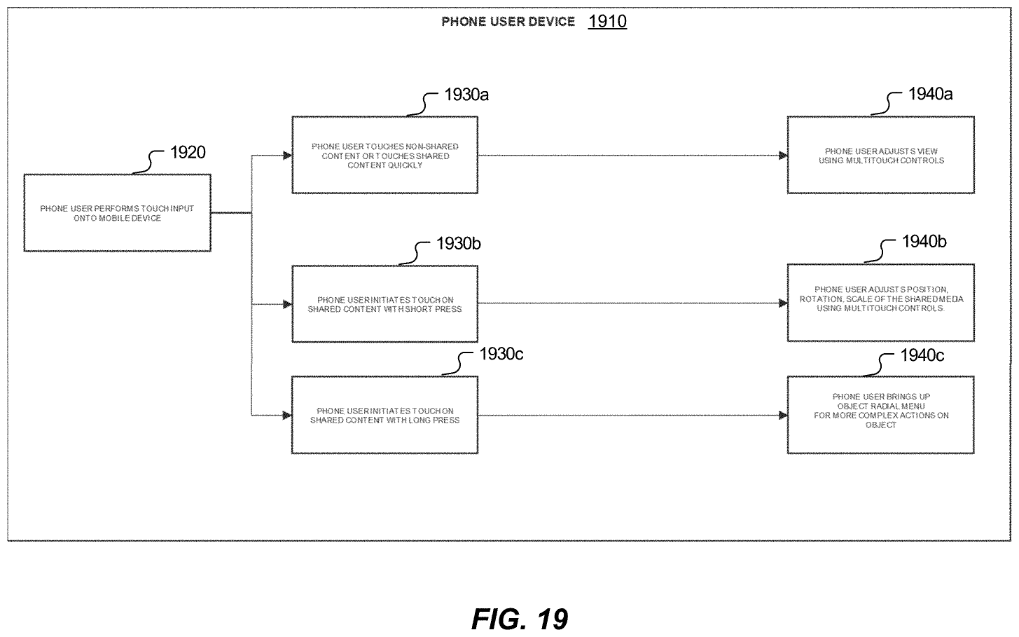

FIG. 19 illustrates an example diagram flow for manipulating the parameters of the XR space with respect to different interactions. As illustrated in FIG. 19, the example diagram flow may be based on a phone user device 1910. At step 1920, the phone user may perform a touch input onto a mobile device. Depending on the type of the gesture input, the subsequent flow may be different. If the phone user touches a non-shared media content or touches a shared media content quickly at step 1930a, the flow may proceed to step 1940a, where the phone user may adjust the view using multi-touch controls. If the phone user initiates a touch on a shared media content with short press at step 1930b, the flow may proceed to step 1940b, where the phone user may adjust the position, rotation, scale of the shared media content using multi-touch controls. If the phone user initiates a touch on a shared media content with long press at step 1930c, the flow may proceed to step 1940c, where the phone user may bring up object radial menu for more complex actions on the object (media content).

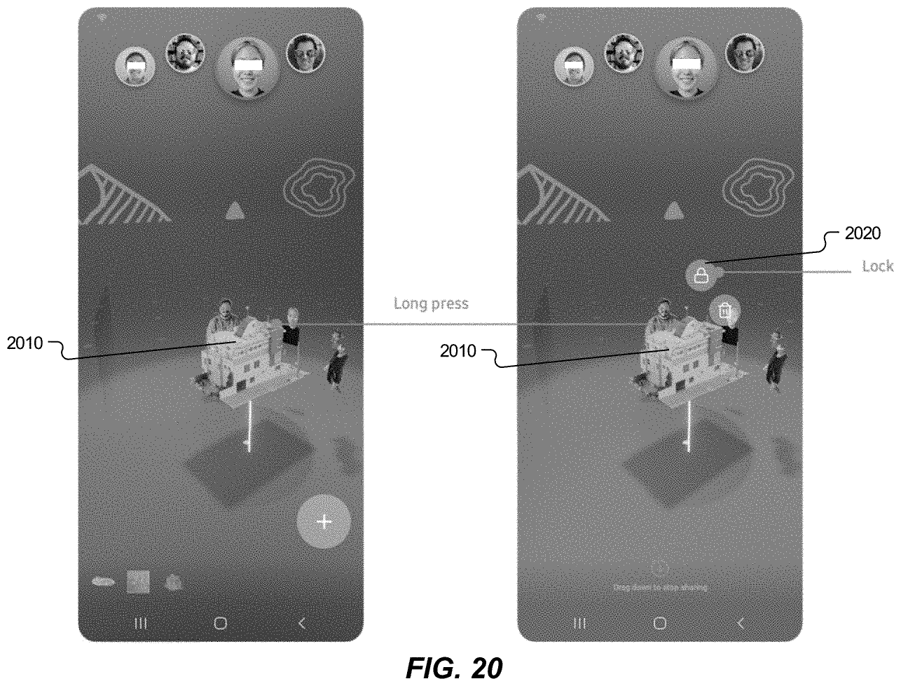

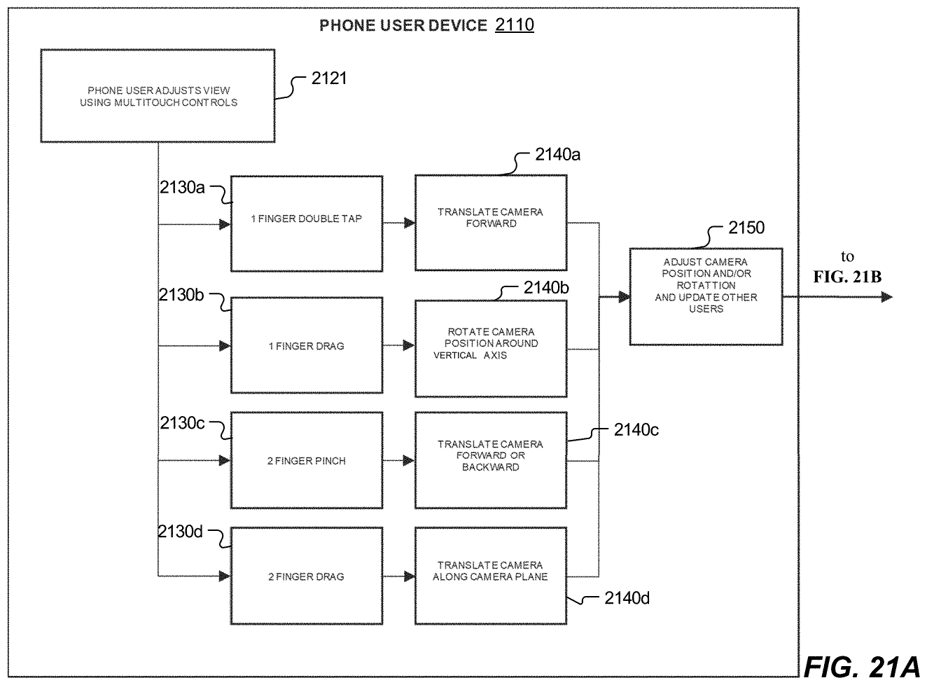

In particular embodiments, manipulating the one or more parameters of the XR space may comprise manipulating one or more XR objects in the XR space. In this case, the one or more gesture inputs may comprise a gesture input for locking the one or more XR objects to prohibit the one or more second users to manipulate the one or more XR objects. In the XR video call, any participant may lock or unlock an object at any time. FIG. 20 illustrates an example locking of a shared object in an XR video call. As illustrated in FIG. 20, the phone user may long-press the XR object 2010 with a single finger to lock the object 2010. After the object 2010 is locked, there may be a lock symbol 2020 on top of the object 2010 indicating that it is locked.

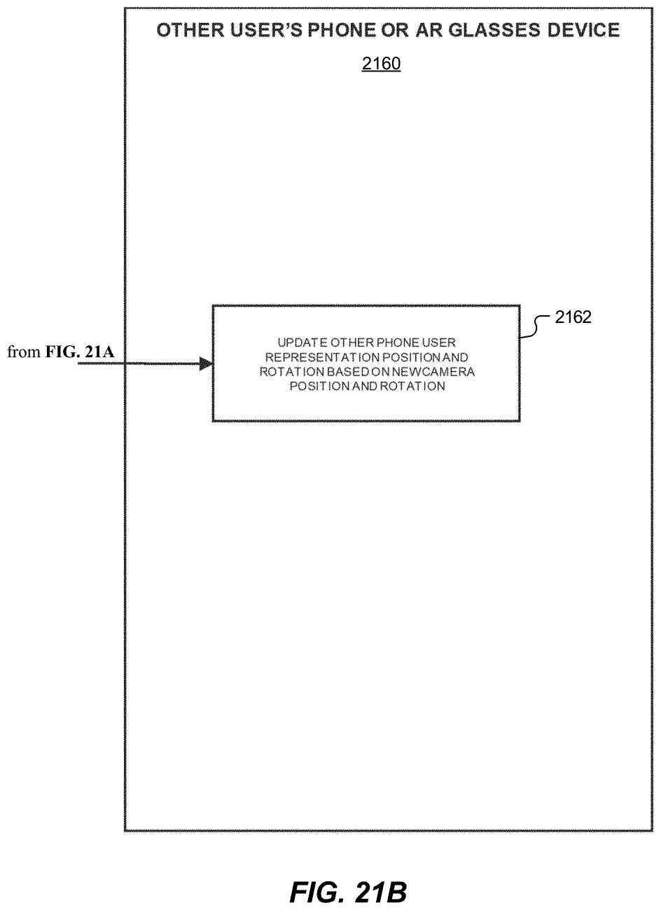

FIG. 21A illustrates an example diagram flow for adjusting the view in an XR video call with respect to the phone user device. On the phone user device 2110, the phone user may adjust the view using multitouch controls at step 2121. Depending on the type of gesture input, there may be different subsequent flows. If the phone user double taps the view with a single finger at step 2130a, the flow may proceed to step 2140a, where the phone user device 2110 may translate the camera forward. If the phone user drags the view with a single finger at step 2130b, the flow may proceed to step 2140b, where the phone user device 2110 may rotate the camera position around the vertical axis. In one embodiment, the camera may rotate around they-axis. In an alternative embodiment, the camera may rotate around a center of the orbit position. If the phone user pinches the view with two fingers at step 2130c, the flow may proceed to step 2140c, where the phone user device 2110 may translate the camera forward or backward. If the phone user drags the view with two fingers at step 2130d, the flow may proceed to step 2140d, where the phone user device 2110 may translate the camera along the camera plane. At step 2150, the phone user device 2110 may adjust camera position and/or rotation and update other users. After step 2150, the diagram flow may proceed to FIG. 21B. FIG. 21B illustrates the example flow diagram for adjusting the view in the XR video call with respect to other user's phone or AR glasses device. The adjustment of the camera position and/or rotation at step 1118 in FIG. 21A may be updated to other user's phone or AR glasses device 2160. At step 2162, the other user's phone or AR glasses device 2160 may update other phone/AR glasses user representation position and rotation based on the new camera position and rotation.

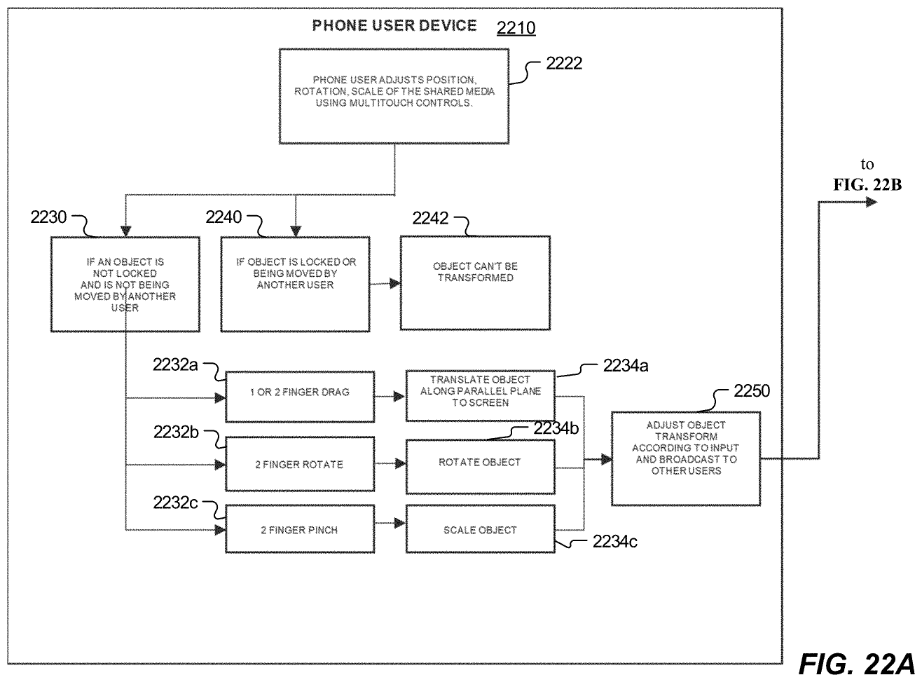

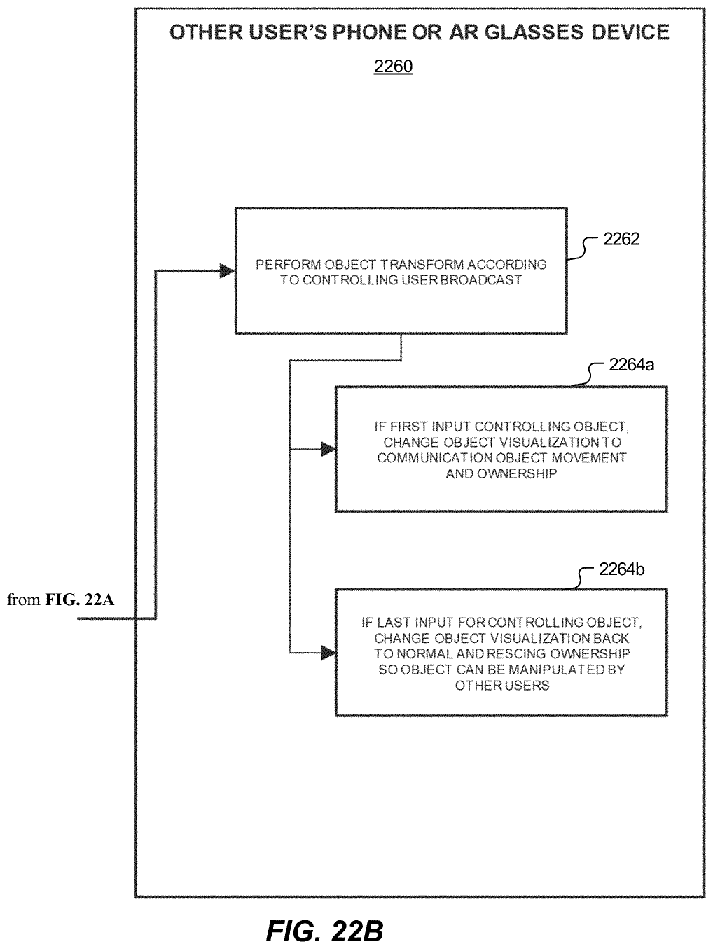

FIG. 22A illustrates an example diagram flow for adjusting the shared media content in an XR video call with respect to the phone user device. On the phone user device 2210, the phone user may adjust the position, rotation, scale of the shared media content using multitouch controls at step 2222. If an object (the shared media content) is not locked and is not being moved by another user at step 2230, the user may proceed with adjusting it with different gesture input. If the object is locked or being moved by another user at step 2240, the diagram flow may proceed to step 2242, where the object cannot be transformed. After step 2230, depending on the type of gesture input, there may be different subsequent flows. If the phone user uses one or two fingers to drag the object at step 2232a, the flow may proceed to step 2234a, where the phone user device 2210 may translate the object along parallel plane to screen. If the phone user uses to fingers to rotate the object at step 2232b, the flow may proceed to step 2234b, where the phone user device 2210 may rotate the object. If the phone user pinches the object with two fingers at step 2232c, the flow may proceed to step 2234c, where the phone user device 2210 may scale the object. Then at step 2250, the phone user device 2210 may adjust the object transformation according to the gesture input and broadcast the adjusted transformation to other users. After step 2250, the diagram flow may proceed to FIG. 22B. If the phone user drags the view with two fingers at step 2230d, the flow may proceed to step 2240d, where the phone user device 2210 may translate the camera along the camera plane. FIG. 22B illustrates the example flow diagram for adjusting the view in the XR video call with respect to other user's phone or AR glasses device. The adjustment of the camera position and/or rotation at step 2250 in FIG. 22A may be updated to other user's phone or AR glasses device 2260. At step 2262, the other user's phone or AR glasses device 2260 may perform object transform according to controlling user broadcast. Then depending on whether it is the first input or last input for controlling the object, there may be different subsequent flows. At step 2264a, if it is first input controlling object, the other user's phone or AR glasses device 2260 may change object visualization to communication object movement and ownership. At step 2264b, if it is last input controlling object, the other user's phone or AR glasses device 2260 may change object visualization back to normal and rescinding ownership so object can be manipulated by other users.

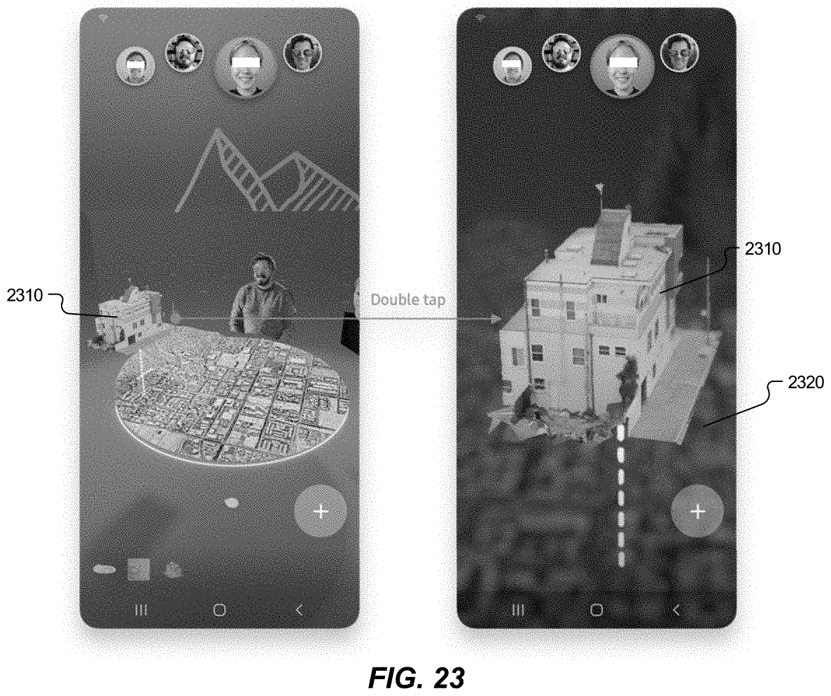

In particular embodiments, the one or more gesture inputs may comprise a gesture input for activating an isolation view. Accordingly, the second sequence of image frames of the XR video call may be rendered in the isolation view. In addition, the portrayed transformations to the XR space in the isolation view may be not visible to the one or more second users. An isolation view may allow for comfortable viewing of the media content without disrupting its placement for other users. A user may double tap on the shared media content with one single finger to activate this view. FIG. 23 illustrates an example isolation view in an XR video call. As illustrated in FIG. 23, a user may double tap on the shared XR object 2310, which may result in an isolation view 2320 for the user. In the isolation view 2320, the selected XR object may come toward to the user.

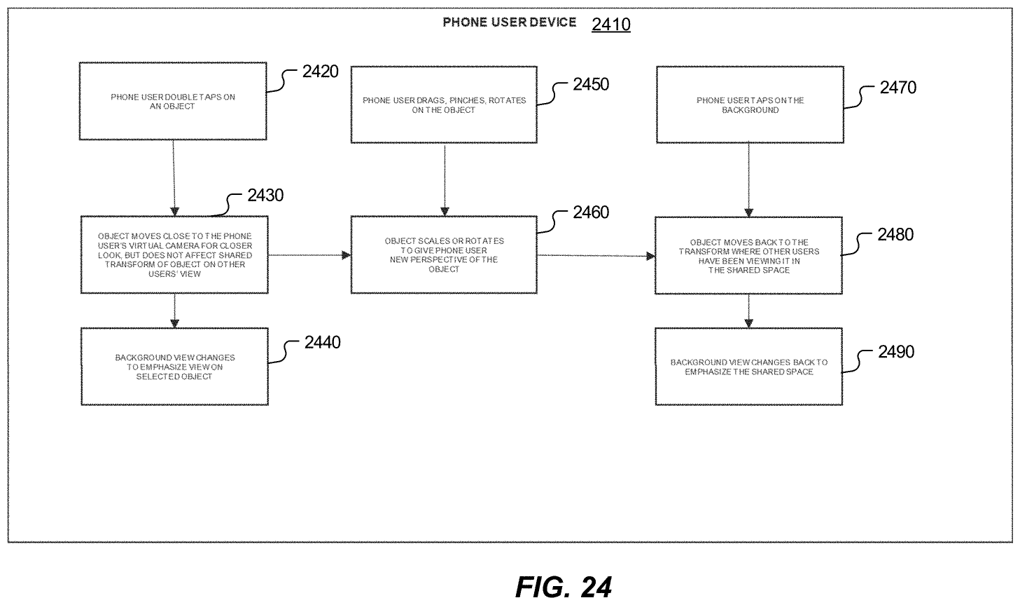

FIG. 24 illustrates an example diagram flow for using an isolation view to view an XR object on a phone user device. On the phone user device 2410, the phone user may double tap on an object at step 2420. At step 2430, the object may move close to the phone user's virtual camera for closer look but may not affect the shared transformation of the object on other users' view. At step 2440, the background view may change to emphasize the view on the selected object. At step 2450, the phone user may drag, pinch, or rotate on the object in the isolation view. At step 2460, the object may scale or rotate to give the phone user a new perspective of the object. At step 240, the phone user may tap on the background. At step 2480, the object may move back to the transform where other users have been viewing it in the shared space. At step 2490, the background view may change back to emphasize the shared space.

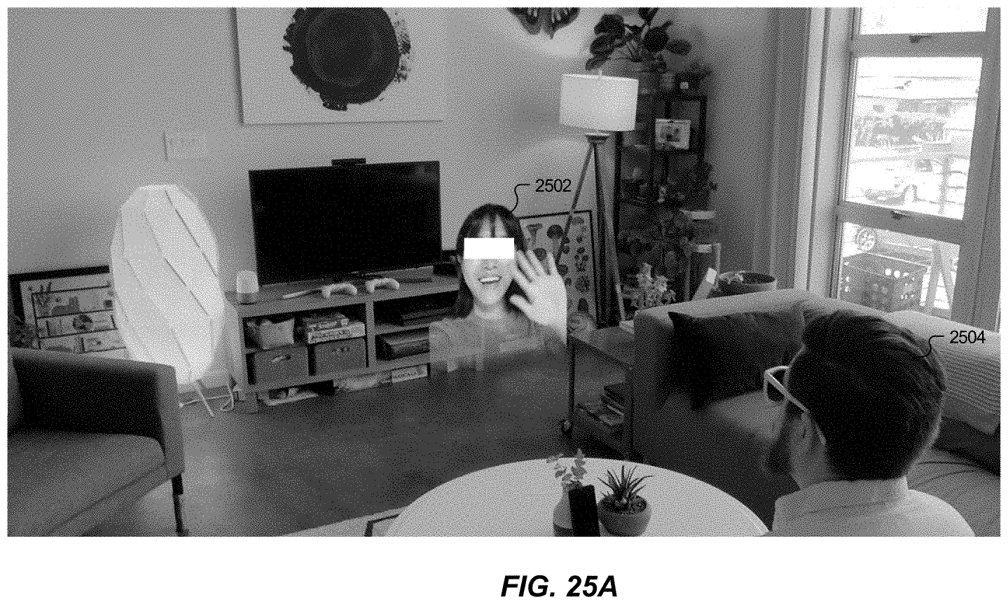

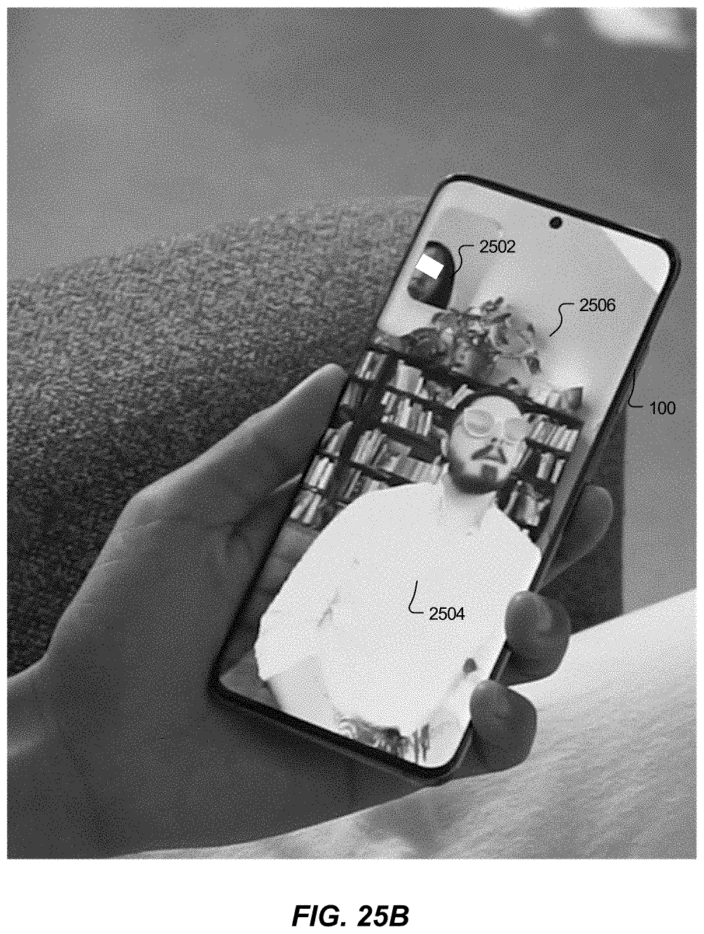

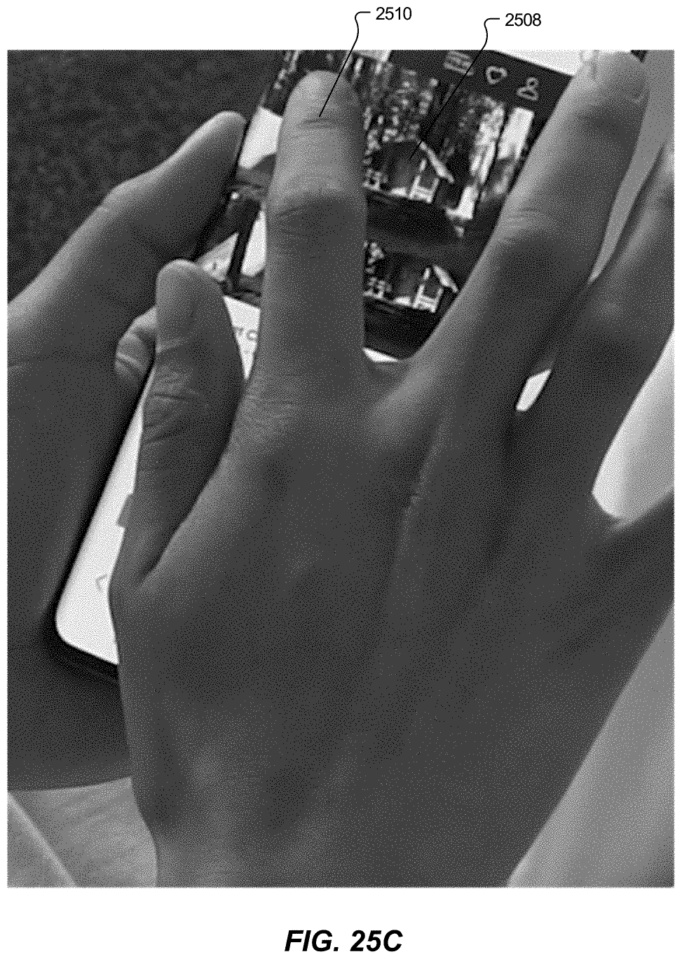

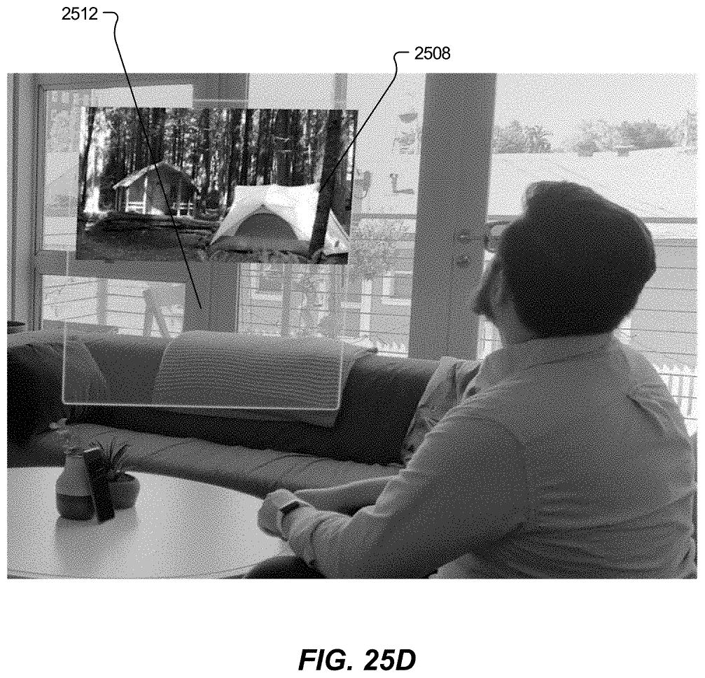

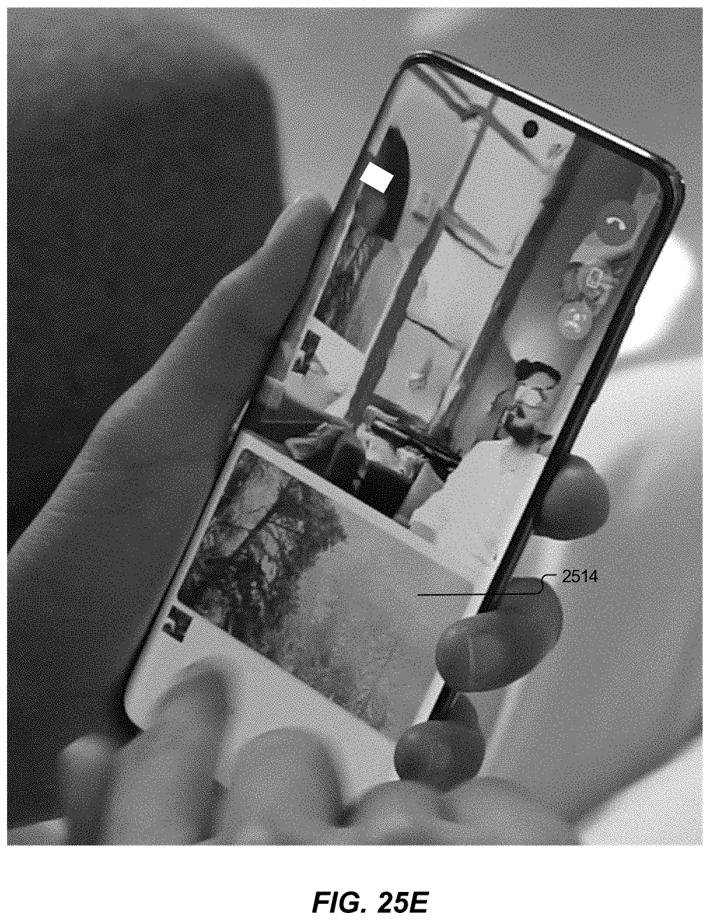

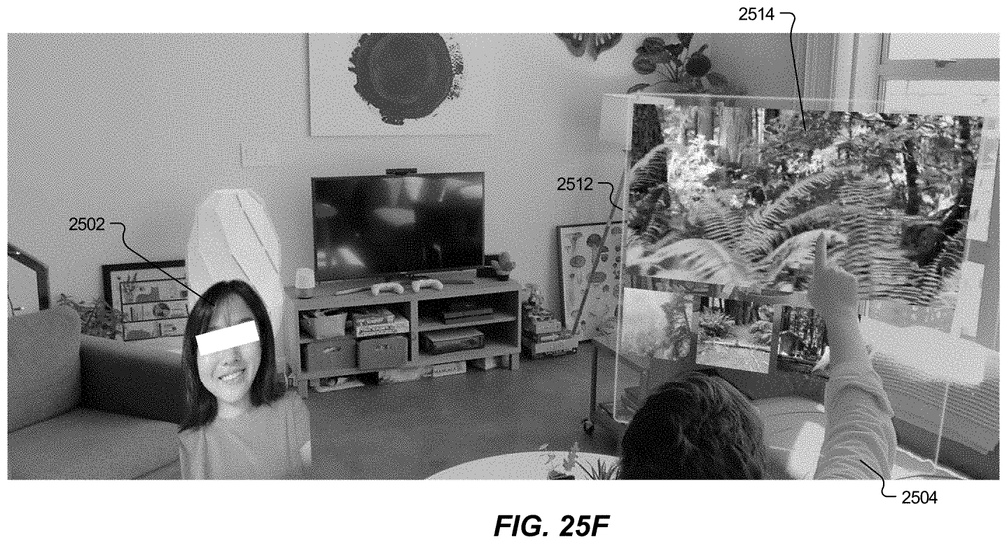

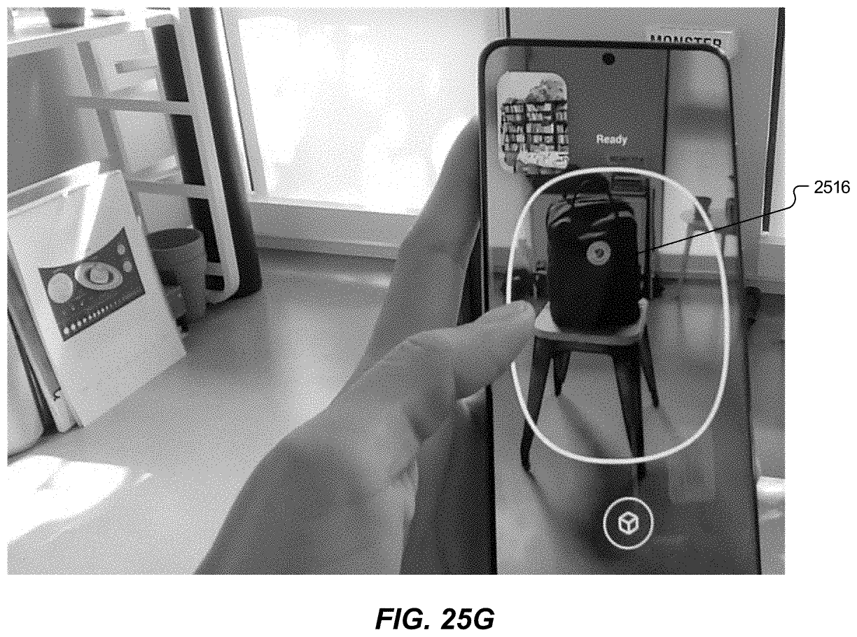

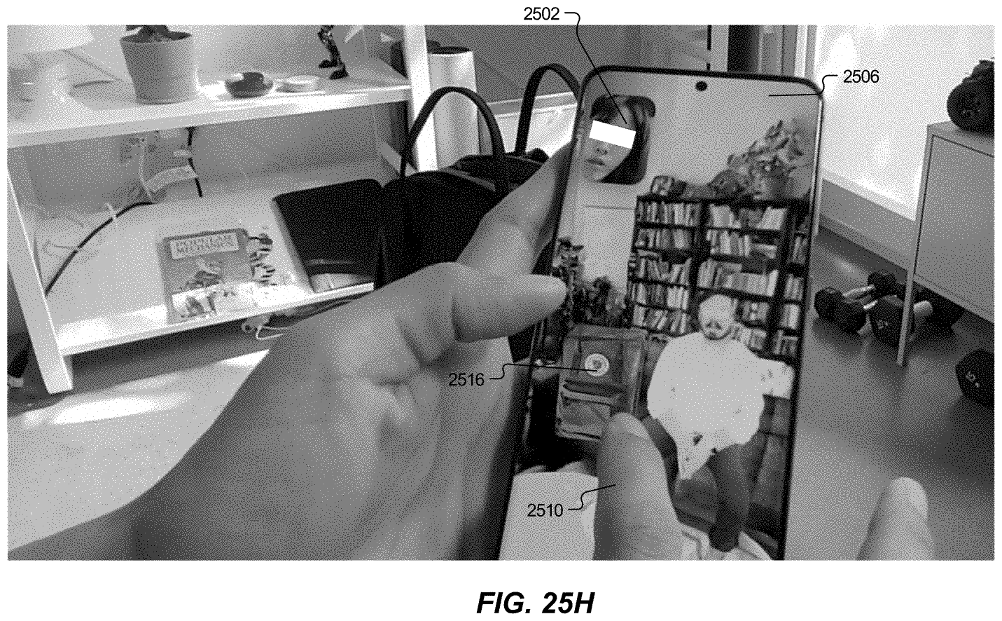

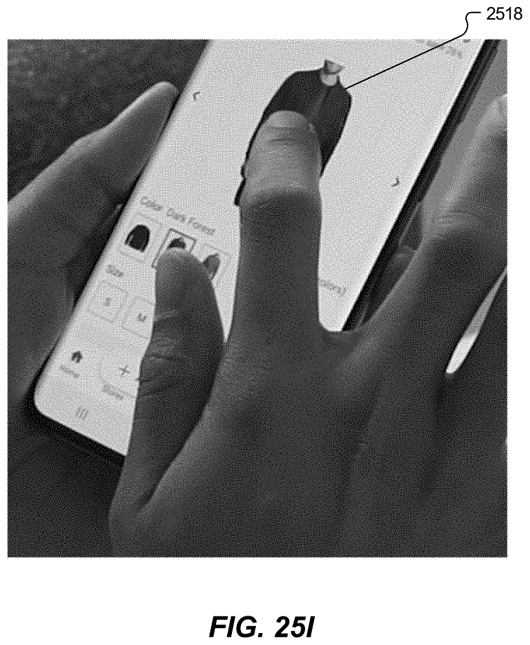

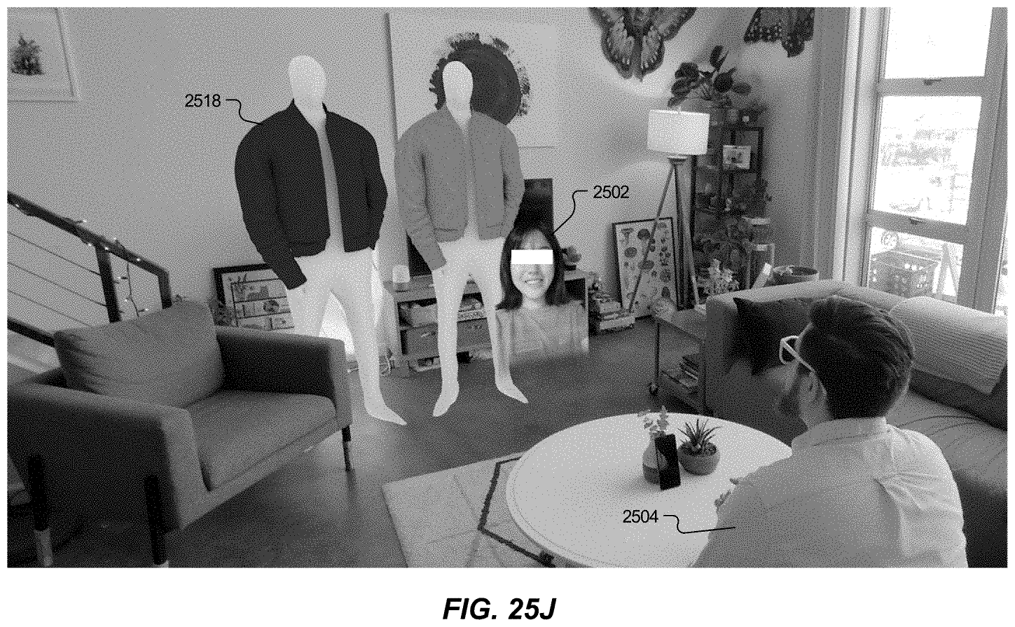

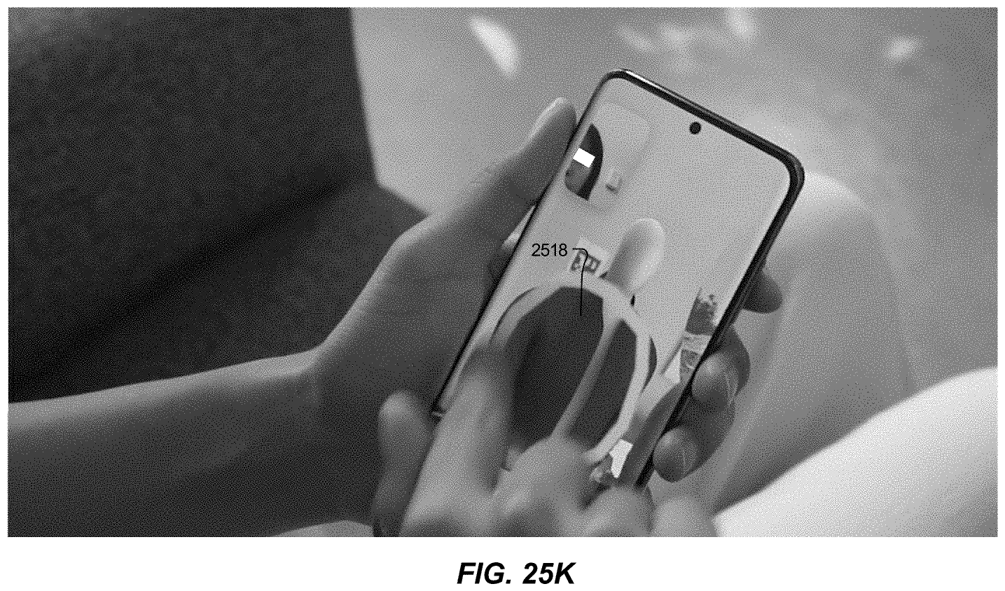

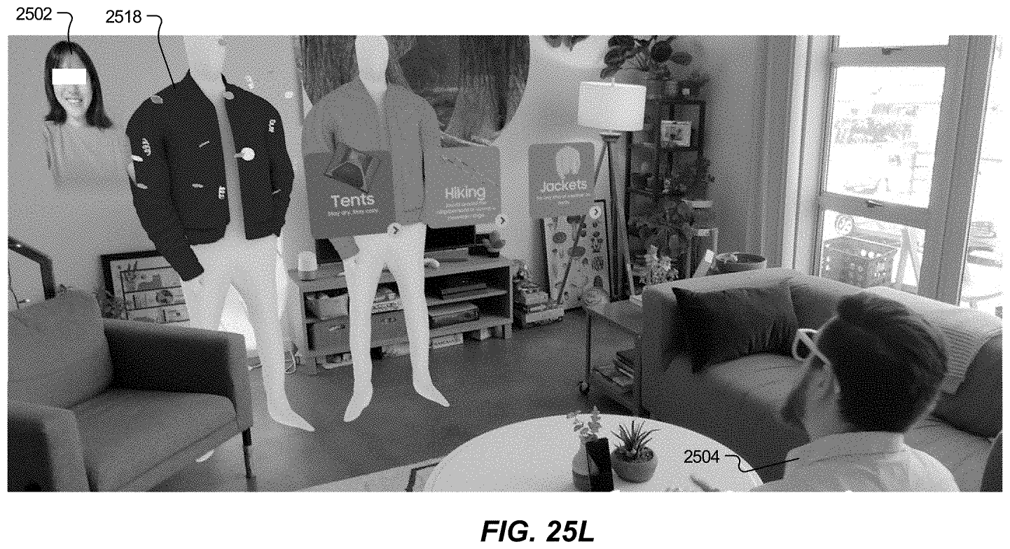

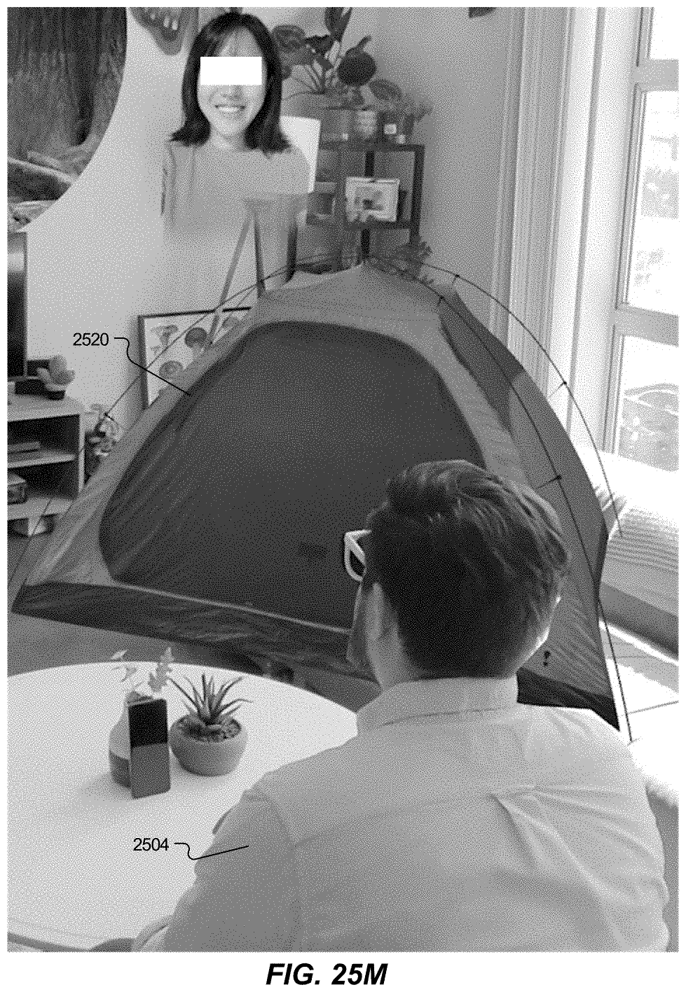

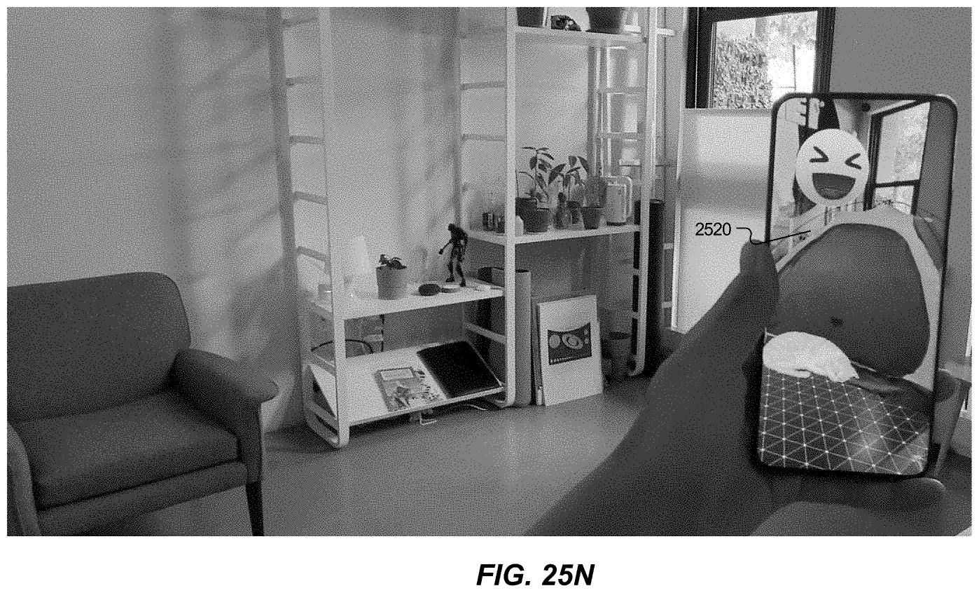

FIGS. 25A-25N illustrate an example XR video call between two users with different parameters being manipulated. FIG. 25A illustrates an example starting of an XR video call. In the XR video call, user 2502 may be using a smart phone whereas user 2504 may be using AR glasses. FIG. 25B illustrates an example view of the XR space during the XR video call by the phone user. In FIG. 25B, the phone user 2502 may see the XR space 2506 on her phone (i.e., the electronic device 100). The XR space 2506 may comprise an XR reproduction of the living room of user 2504 and an XR representation of user 2504. FIG. 25C illustrates an example sharing of a media content from the Internet by the phone user. As illustrated in FIG. 25C, user 2502 may share a picture 2508 from the Internet to the XR video call by tapping it with a single finger 2510. FIG. 25D illustrates an example view of the shared media content by the other user wearing AR glasses. As illustrated in FIG. 25D, after user 2502 shared the picture 2508 from her phone, user 2504 may see the shared picture 2508 on a display 2512 of the AR glasses. FIG. 25E illustrates an example sharing of a media content from the gallery of the phone by the phone user. As illustrated in FIG. 25E, user 2502 may share a video 2514 from the gallery on her phone to the XR video call. FIG. 25F illustrates an example view of the shared media content by the other user wearing AR glasses.

As illustrated in FIG. 25F, after user 2502 shared the video 2514 from her phone, user 2504 may watch the shared video 2514 on a display 2512 of the AR glasses together with user 2502 who watches the video 2514 on her phone. FIG. 25G illustrates an example 3D scanning of an object by the phone user. As illustrated in FIG. 25G, user 2502 may do a 3D scanning of a backpack 2516 on her phone. FIG. 25H illustrates an example sharing of the scanned 3D object by the phone user. As illustrated in FIG. 25H, user 2502 may share the scanned 3D object of the backpack 2516 to the XR video call by dragging it to the XR space 2506 using a single finger 2510. FIG. 25I illustrates an example sharing of a media content from the Internet by the phone user. As illustrated in FIG. 25I, user 2502 may share a picture 2518 of a jacket from the Internet to the XR video call. FIG. 25J illustrates an example view of the shared media content by the other user wearing AR glasses. As illustrated in FIG. 25I, after user 2502 shared the picture 2518 of the jacket, user 2504 may see the jacket 2518 as a 3D object via the AR glasses. FIG. 25K illustrates an example highlight of the shared media content by the phone user. As illustrated in FIG. 25I, user 2502 may have shared two jackets to the XR video call. Subsequently, user 2502 may point to which one she is talking about by circling the jacket 2518. FIG. 25L illustrates an example view of the highlighted media content by the other user wearing AR glasses. As illustrated in FIG. 25L, after user 2502 highlighted the jacket 2518, user 2504 may see the jacket 2518 with stickers via the AR glasses. FIG. 25M illustrates an example sharing of a 3D object by the other user wearing AR glasses. As illustrated in FIG. 25M, user 2504 may also share media content from his AR glasses. For example, user 2504 may have shared a 3D object of a tent 2520. The tent 2520 may be visualized as an AR object in his living room. FIG. 25N illustrates an example view of the shared 3D object by the phone user. As illustrated in FIG. 25N, after user 2504 shared the 3D object of the tent 2520, user 2502 may view it on her phone in an AR passthrough mode. The 3D object of the tent 2520 may be visualized as in her own space.

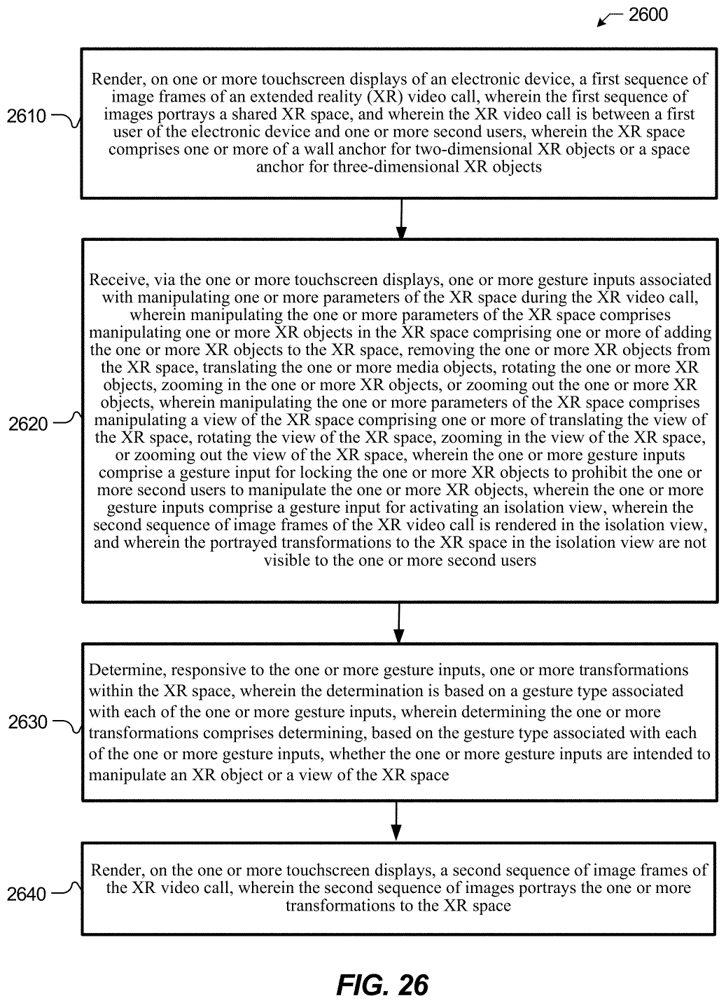

FIG. 26 illustrates is a flow diagram of a method for manipulating parameters of an XR space during an XR video call. The method 2600 may be performed utilizing one or more processing devices (e.g., an electronic device 100) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing 2D and 3D image data, software (e.g., instructions running/executing on one or more processors), firmware (e.g., microcode), or some combination thereof.

The method 2600 may begin at step 2610 with the one or more processing devices (e.g., the electronic device 100). For example, in particular embodiments, the electronic device 100 may render, on one or more touchscreen displays of the electronic device, a first sequence of image frames of an extended reality (XR) video call, wherein the first sequence of images portrays a shared XR space, and wherein the XR video call is between a first user of the electronic device 100 and one or more second users, wherein the XR space comprises one or more of a wall anchor for two-dimensional XR objects or a space anchor for three-dimensional XR objects. The method 2600 may then continue at step 2620 with the one or more processing devices (e.g., the electronic device 100). For example, in particular embodiments, the electronic device 100 may receive, via the one or more touchscreen displays, one or more gesture inputs associated with manipulating one or more parameters of the XR space during the XR video call, wherein manipulating the one or more parameters of the XR space comprises manipulating one or more XR objects in the XR space comprising one or more of adding the one or more XR objects to the XR space, removing the one or more XR objects from the XR space, translating the one or more media objects, rotating the one or more XR objects, zooming in the one or more XR objects, or zooming out the one or more XR objects, wherein manipulating the one or more parameters of the XR space comprises manipulating a view of the XR space comprising one or more of translating the view of the XR space, rotating the view of the XR space, zooming in the view of the XR space, or zooming out the view of the XR space, wherein the one or more gesture inputs comprise a gesture input for locking the one or more XR objects to prohibit the one or more second users to manipulate the one or more XR objects, wherein the one or more gesture inputs comprise a gesture input for activating an isolation view, wherein the second sequence of image frames of the XR video call is rendered in the isolation view, and wherein the portrayed transformations to the XR space in the isolation view are not visible to the one or more second users. The method 2600 may then continue at step 2630 with the one or more processing devices (e.g., the electronic device 100). For example, in particular embodiments, the electronic device 100 may determine, responsive to the one or more gesture inputs, one or more transformations within the XR space, wherein the determination is based on a gesture type associated with each of the one or more gesture inputs, wherein determining the one or more transformations comprises determining, based on the gesture type associated with each of the one or more gesture inputs, whether the one or more gesture inputs are intended to manipulate an XR object or a view of the XR space. The method 2600 may then continue at block 2640 with the one or more processing devices (e.g., the electronic device 100). For example, in particular embodiments, the electronic device 100 may render, on the one or more touchscreen displays, a second sequence of image frames of the XR video call, wherein the second sequence of images portrays the one or more transformations to the XR space. Particular embodiments may repeat one or more steps of the method of FIG. 26, where appropriate. Although this disclosure describes and illustrates particular steps of the method of FIG. 26 as occurring in a particular order, this disclosure contemplates any suitable steps of the method of FIG. 26 occurring in any suitable order. Moreover, although this disclosure describes and illustrates an example method for manipulating parameters of an XR space during an XR video call including the particular steps of the method of FIG. 26, this disclosure contemplates any suitable method for manipulating parameters of an XR space during an XR video call including any suitable steps, which may include all, some, or none of the steps of the method of FIG. 26, where appropriate. Furthermore, although this disclosure describes and illustrates particular components, devices, or systems carrying out particular steps of the method of FIG. 26, this disclosure contemplates any suitable combination of any suitable components, devices, or systems carrying out any suitable steps of the method of FIG. 26.

### Systems and Methods

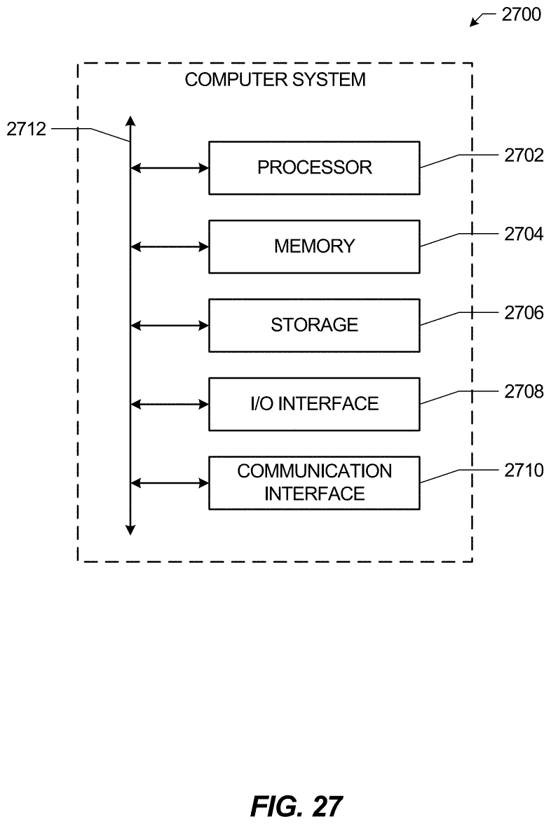

FIG. 27 illustrates an example computer system 2700 that may be utilized to perform manipulating parameters of an XR space during an XR video call. In particular embodiments, one or more computer systems 2700 perform one or more steps of one or more methods described or illustrated herein. In particular embodiments, one or more computer systems 2700 provide functionality described or illustrated herein. In particular embodiments, software running on one or more computer systems 2700 performs one or more steps of one or more methods described or illustrated herein or provides functionality described or illustrated herein. Particular embodiments include one or more portions of one or more computer systems 2700. Herein, reference to a computer system may encompass a computing device, and vice versa, where appropriate. Moreover, reference to a computer system may encompass one or more computer systems, where appropriate.

This disclosure contemplates any suitable number of computer systems 2700. This disclosure contemplates computer system 2700 taking any suitable physical form. As example and not by way of limitation, computer system 2700 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 2700 may include one or more computer systems 2700; be unitary or distributed; span multiple locations; span multiple machines; span multiple data centers; or reside in a cloud, which may include one or more cloud components in one or more networks.

Where appropriate, one or more computer systems 2700 may perform without substantial spatial or temporal limitation one or more steps of one or more methods described or illustrated herein. As an example, and not by way of limitation, one or more computer systems 2700 may perform in real time or in batch mode one or more steps of one or more methods described or illustrated herein. One or more computer systems 2700 may perform at different times or at different locations one or more steps of one or more methods described or illustrated herein, where appropriate.

In particular embodiments, computer system 2700 includes a processor 2702, memory 2704, storage 2706, an input/output (I/O) interface 2708, a communication interface 2710, and a bus 2712. Although this disclosure describes and illustrates a particular computer system having a particular number of particular components in a particular arrangement, this disclosure contemplates any suitable computer system having any suitable number of any suitable components in any suitable arrangement. In particular embodiments, processor 2702 includes hardware for executing instructions, such as those making up a computer program. As an example, and not by way of limitation, to execute instructions, processor 2702 may retrieve (or fetch) the instructions from an internal register, an internal cache, memory 2704, or storage 2706; decode and execute them; and then write one or more results to an internal register, an internal cache, memory 2704, or storage 2706. In particular embodiments, processor 2702 may include one or more internal caches for data, instructions, or addresses. This disclosure contemplates processor 2702 including any suitable number of any suitable internal caches, where appropriate. As an example, and not by way of limitation, processor 2702 may include one or more instruction caches, one or more data caches, and one or more translation lookaside buffers (TLBs). Instructions in the instruction caches may be copies of instructions in memory 2704 or storage 2706, and the instruction caches may speed up retrieval of those instructions by processor 2702.

Data in the data caches may be copies of data in memory 2704 or storage 2706 for instructions executing at processor 2702 to operate on; the results of previous instructions executed at processor 2702 for access by subsequent instructions executing at processor 2702 or for writing to memory 2704 or storage 2706; or other suitable data. The data caches may speed up read or write operations by processor 2702. The TLBs may speed up virtual-address translation for processor 2702. In particular embodiments, processor 2702 may include one or more internal registers for data, instructions, or addresses. This disclosure contemplates processor 2702 including any suitable number of any suitable internal registers, where appropriate. Where appropriate, processor 2702 may include one or more arithmetic logic units (ALUs); be a multi-core processor; or include one or more processors 2702. Although this disclosure describes and illustrates a particular processor, this disclosure contemplates any suitable processor.

In particular embodiments, memory 2704 includes main memory for storing instructions for processor 2702 to execute or data for processor 2702 to operate on. As an example, and not by way of limitation, computer system 2700 may load instructions from storage 2706 or another source (such as, for example, another computer system 2700) to memory 2704. Processor 2702 may then load the instructions from memory 2704 to an internal register or internal cache. To execute the instructions, processor 2702 may retrieve the instructions from the internal register or internal cache and decode them. During or after execution of the instructions, processor 2702 may write one or more results (which may be intermediate or final results) to the internal register or internal cache. Processor 2702 may then write one or more of those results to memory 2704. In particular embodiments, processor 2702 executes only instructions in one or more internal registers or internal caches or in memory 2704 (as opposed to storage 2706 or elsewhere) and operates only on data in one or more internal registers or internal caches or in memory 2704 (as opposed to storage 2706 or elsewhere).

One or more memory buses (which may each include an address bus and a data bus) may couple processor 2702 to memory 2704. Bus 2712 may include one or more memory buses, as described below. In particular embodiments, one or more memory management units (MMUs) reside between processor 2702 and memory 2704 and facilitate accesses to memory 2704 requested by processor 2702. In particular embodiments, memory 2704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2704 may include one or more memory devices 2704, where appropriate. Although this disclosure describes and illustrates particular memory, this disclosure contemplates any suitable memory.

In particular embodiments, storage 2706 includes mass storage for data or instructions. As an example, and not by way of limitation, storage 2706 may include a hard disk drive (HDD), a floppy disk drive, flash memory, an optical disc, a magneto-optical disc, magnetic tape, or a Universal Serial Bus (USB) drive or a combination of two or more of these. Storage 2706 may include removable or non-removable (or fixed) media, where appropriate. Storage 2706 may be internal or external to computer system 2700, where appropriate. In particular embodiments, storage 2706 is non-volatile, solid-state memory. In particular embodiments, storage 2706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2706 taking any suitable physical form. Storage 2706 may include one or more storage control units facilitating communication between processor 2702 and storage 2706, where appropriate. Where appropriate, storage 2706 may include one or more storages 2706. Although this disclosure describes and illustrates particular storage, this disclosure contemplates any suitable storage.

In particular embodiments, I/O interface 2708 includes hardware, software, or both, providing one or more interfaces for communication between computer system 2700 and one or more I/O devices. Computer system 2700 may include one or more of these I/O devices, where appropriate. One or more of these I/O devices may enable communication between a person and computer system 2700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2706 for them. Where appropriate, I/O interface 2708 may include one or more device or software drivers enabling processor 2702 to drive one or more of these I/O devices. I/O interface 2708 may include one or more I/O interfaces 2706, where appropriate. Although this disclosure describes and illustrates a particular I/O interface, this disclosure contemplates any suitable I/O interface.

In particular embodiments, communication interface 2710 includes hardware, software, or both providing one or more interfaces for communication (such as, for example, packet-based communication) between computer system 2700 and one or more other computer systems 2700 or one or more networks. As an example, and not by way of limitation, communication interface 2710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2710 for it.

As an example, and not by way of limitation, computer system 2700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2700 may include any suitable communication interface 2710 for any of these networks, where appropriate. Communication interface 2710 may include one or more communication interfaces 2710, where appropriate. Although this disclosure describes and illustrates a particular communication interface, this disclosure contemplates any suitable communication interface.

In particular embodiments, bus 2712 includes hardware, software, or both coupling components of computer system 2700 to each other. As an example, and not by way of limitation, bus 2712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2712 may include one or more buses 2712, where appropriate. Although this disclosure describes and illustrates a particular bus, this disclosure contemplates any suitable bus or interconnect.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An electronic device comprising:
one or more touchscreen displays;
one or more non-transitory computer-readable storage media including instructions; and
one or more processors coupled to the storage media, the one or more processors configured to execute the instructions to:
render, on the one or more touchscreen displays, a first sequence of image frames of an extended reality (XR) video call, wherein the first sequence of images portrays a shared XR space, and wherein the XR video call is between a first user of the electronic device and one or more second users;
receive, via the one or more touchscreen displays, one or more gesture inputs associated with manipulating one or more parameters of the XR space during the XR video call;
determine, responsive to the one or more gesture inputs, one or more transformations within the XR space, wherein the determination is based on a gesture type associated with each of the one or more gesture inputs; and
render, on the one or more touchscreen displays, a second sequence of image frames of the XR video call, wherein the second sequence of images portrays the one or more transformations to the XR space.

2. The electronic device of claim 1, wherein the XR space comprises one or more of a wall anchor for two-dimensional XR objects or a space anchor for three-dimensional XR objects.

3. The electronic device of claim 1, wherein determining the one or more transformations comprises:
determining, based on the gesture type associated with each of the one or more gesture inputs, whether the one or more gesture inputs are intended to manipulate an XR object or a view of the XR space.

4. The electronic device of claim 1, wherein manipulating the one or more parameters of the XR space comprises manipulating one or more XR objects in the XR space, and wherein manipulating the one or more XR objects comprises one or more of adding the one or more XR objects to the XR space, removing the one or more XR objects from the XR space, translating the one or more media objects, rotating the one or more XR objects, zooming in the one or more XR objects, or zooming out the one or more XR objects.

5. The electronic device of claim 1, wherein manipulating the one or more parameters of the XR space comprises manipulating a view of the XR space, and wherein manipulating the view of the XR space comprises one or more of translating the view of the XR space, rotating the view of the XR space, zooming in the view of the XR space, or zooming out the view of the XR space.

6. The electronic device of claim 1, wherein manipulating the one or more parameters of the XR space comprises manipulating one or more XR objects in the XR space, and wherein the one or more gesture inputs comprise a gesture input for locking the one or more XR objects to prohibit the one or more second users to manipulate the one or more XR objects.

7. The electronic device of claim 1, wherein the one or more gesture inputs comprise a gesture input for activating an isolation view, wherein the second sequence of image frames of the XR video call is rendered in the isolation view, and wherein the portrayed transformations to the XR space in the isolation view are not visible to the one or more second users.

8. A method comprising, by an electronic device:
rendering, on one or more touchscreen displays of the electronic device, a first sequence of image frames of an extended reality (XR) video call, wherein the first sequence of images portrays a shared XR space, and wherein the XR video call is between a first user of the electronic device and one or more second users;
receiving, via the one or more touchscreen displays, one or more gesture inputs associated with manipulating one or more parameters of the XR space during the XR video call;
determining, responsive to the one or more gesture inputs, one or more transformations within the XR space, wherein the determination is based on a gesture type associated with each of the one or more gesture inputs; and
rendering, on the one or more touchscreen displays, a second sequence of image frames of the XR video call, wherein the second sequence of images portrays the one or more transformations to the XR space.

9. The method of claim 8, wherein the XR space comprises one or more of a wall anchor for two-dimensional XR objects or a space anchor for three-dimensional XR objects.

10. The method of claim 8, wherein determining the one or more transformations comprises:
determining, based on the gesture type associated with each of the one or more gesture inputs, whether the one or more gesture inputs are intended to manipulate an XR object or a view of the XR space:

11. The method of claim 8, wherein manipulating the one or more parameters of the XR space comprises manipulating one or more XR objects in the XR space, and wherein manipulating the one or more XR objects comprises one or more of adding the one or more XR objects to the XR space, removing the one or more XR objects from the XR space, translating the one or more media objects, rotating the one or more XR objects, zooming in the one or more XR objects, or zooming out the one or more XR objects.

12. The method of claim 8, wherein manipulating the one or more parameters of the XR space comprises manipulating a view of the XR space, and wherein manipulating the view of the XR space comprises one or more of translating the view of the XR space, rotating the view of the XR space, zooming in the view of the XR space, or zooming out the view of the XR space.

13. The method of claim 8, wherein manipulating the one or more parameters of the XR space comprises manipulating one or more XR objects in the XR space, and wherein the one or more gesture inputs comprise a gesture input for locking the one or more XR objects to prohibit the one or more second users to manipulate the one or more XR objects.

14. The method of claim 8, wherein the one or more gesture inputs comprise a gesture input for activating an isolation view, wherein the second sequence of image frames of the XR video call is rendered in the isolation view, and wherein the portrayed transformations to the XR space in the isolation view are not visible to the one or more second users.

15. A computer-readable non-transitory storage media comprising instructions executable by a processor to:
render, on one or more touchscreen displays of an electronic device, a first sequence of image frames of an extended reality (XR) video call, wherein the first sequence of images portrays a shared XR space, and wherein the XR video call is between a first user of the electronic device and one or more second users;
receive, via the one or more touchscreen displays, one or more gesture inputs associated with manipulating one or more parameters of the XR space during the XR video call;
determine, responsive to the one or more gesture inputs, one or more transformations within the XR space, wherein the determination is based on a gesture type associated with each of the one or more gesture inputs; and
render, on the one or more touchscreen displays, a second sequence of image frames of the XR video call, wherein the second sequence of images portrays the one or more transformations to the XR space.

16. The media of claim 15, wherein the XR space comprises one or more of a wall anchor for two-dimensional XR objects or a space anchor for three-dimensional XR objects.

17. The media of claim 15, wherein determining the one or more transformations comprises:
determining, based on the gesture type associated with each of the one or more gesture inputs, whether the one or more gesture inputs are intended to manipulate an XR object or a view of the XR space.

18. The media of claim 15, wherein manipulating the one or more parameters of the XR space comprises manipulating one or more XR objects in the XR space, and wherein manipulating the one or more XR objects comprises one or more of adding the one or more XR objects to the XR space, removing the one or more XR objects from the XR space, translating the one or more media objects, rotating the one or more XR objects, zooming in the one or more XR objects, or zooming out the one or more XR objects.

19. The media of claim 15, wherein manipulating the one or more parameters of the XR space comprises manipulating a view of the XR space, and wherein manipulating the view of the XR space comprises one or more of translating the view of the XR space, rotating the view of the XR space, zooming in the view of the XR space, or zooming out the view of the XR space.

20. The media of claim 15, wherein manipulating the one or more parameters of the XR space comprises manipulating one or more XR objects in the XR space, and wherein the one or more gesture inputs comprise a gesture input for locking the one or more XR objects to prohibit the one or more second users to manipulate the one or more XR objects.
